(19) United States
(12) Patent Application Publication
(10) Pub. No.: US 2008/0112859 A1
(43) Pub. Date: May 15, 2008

(54) Fuel Gas Processing Apparatus

(76) Inventors: Shigenori Onuma, Aichi-ken (JP); Koichi Kuwaba, Aichi-ken (JP); Takashi Amano, Aichi-ken (JP); Takashi Ishikawa, Aichi-ken (JP); Hitoshi Yoshiguchi, Aichi-ken (JP); Atsushi Takumi, Aichi-ken (JP)

Correspondence Address: KENYON & KENYON LLP, 1500 K STREET N.W., SUITE 700, WASHINGTON, DC, 20005, US

(21) Appl. No.: 11/884,019

(22) PCT Filed: Feb. 16, 2006
(86) PCT No.: PCT/JP06/03214

§ 371 Date: Aug. 9, 2007

(30) Foreign Application Priority Data
Feb. 16, 2005 (JP) 2005-039657
Feb. 16, 2005 (JP) 2005-039678
Feb. 24, 2005 (JP) 2005-049709

(51) Int. Cl. B01J 8/04

(52) U.S. Cl. 422/189; 422/198

(57) ABSTRACT

A fuel gas processing apparatus includes a gas supply portion for supplying a fuel gas containing carbon monoxide and a catalytic combustion portion for catalytically oxidizing the fuel gas supplied from the gas supply portion. The fuel gas processing apparatus includes a carbon monoxide reduction portion for reducing the amount of carbon monoxide contained in the fuel gas before the fuel gas is supplied to the catalytic combustion portion to enhance combustibility of the catalytic combustion portion.

### TECHNICAL FIELD

The present invention generally relates to a fuel gas processing apparatus.

### BACKGROUND ART

Conventionally, a fuel gas processing apparatus is known which includes a gas supply portion for supplying a fuel gas and a catalytic combustion portion for catalytically combusting the fuel gas. Such fuel gas processing apparatus can be applied to a conventional reforming apparatus, including a reforming portion for steam reforming of a material for reforming to produce a reformed gas and a carbon monoxide (CO) reduction portion for reducing the amount of carbon monoxide contained in the reformed gas produced in the reforming portion. In such reforming apparatus, the reformed gas (fuel gas) produced in the reforming portion (gas supply portion) is oxidized and combusted in the catalytic combustion portion. At this time, the catalytic combustion portion can have, as a warming-up portion, a function for warming-up of the reforming portion, the CO reduction portion, or the like, at the time of startup of the reforming apparatus. Such technique for warming-up of the reforming portion, the CO reduction portion, or the like, at the time of starting the reforming apparatus, is highly requested in industrial field.

However, in the case the gas processing apparatus is applied to the reforming apparatus described above, the fuel gas (reformed gas) supplied from the fuel supply portion (reforming portion) tends to contain CO produced in steam reforming reaction. When the fuel gas containing CO is supplied to the catalytic combustion portion, CO tends to adhere to a catalyst in the catalytic combustion portion. Accordingly, there is a danger that ignitionability and combustibility of the catalyst is degraded. JP2003-081687A describes a technique for catalytically combusting a fuel gas containing CO with use of a catalyst containing a PdO and Pt as catalyst components. This document describes that such catalyst components are effective for catalytically combusting the fuel gas containing CO. However, according to this technique, in a case where the amount of CO contained in the fuel gas (reformed gas) is excessive, there can be a danger that CO contained in the fuel gas (reformed gas) adheres to the catalyst in the catalytic combustion portion, whereby ignitionability and combustibility of the catalyst would be degraded. When ignitionability and combustibility of the catalyst are degraded, there is a danger that the warming-up portion cannot be warmed up early.

Further, when the fuel gas processing apparatus is applied to the reforming portion, the reformed gas supplied from the fuel supply portion (reforming portion) tends to contain moisture (water vapor, water droplets, or the like) utilized in steam reforming reaction. When moisture (water vapor, water droplets, or the like) is contained in the reformed gas, moisture tends to physically adhere to a main body of the warming-up portion for warming-up of the reforming portion, the CO reduction portion, or the like. Accordingly, there is a danger that ignitionability, combustibility, and temperature rise property are degraded. Particularly, when the catalytic combustion portion, including the catalyst for catalytic combustion, of the fuel gas processing apparatus is utilized as the main body of the warming-up portion, if moisture adheres to reaction sites of the catalyst, there is a danger that activity of the catalyst is lowered, and in turn warming-up performance of the main body of the warming-up portion is lowered.

A need thus exists for a fuel gas processing apparatus, which is advantageous for improving ignitionability and combustibility in the catalytic combustion portion of the fuel gas processing apparatus. The present invention has been made in view of the above circumstances and provides such a fuel gas processing apparatus.

### DISCLOSURE OF THE INVENTION

According to an aspect of the present invention, a fuel gas processing apparatus includes a gas supply portion for supplying a fuel gas containing carbon monoxide and a catalytic combustion portion for catalytically oxidizing the fuel gas supplied from the gas supply portion. The fuel gas processing apparatus includes a carbon monoxide reduction portion for reducing the amount of carbon monoxide contained in the fuel gas before the fuel gas is supplied to the catalytic combustion portion to enhance combustibility of the catalytic combustion portion.

### BRIEF DESCRIPTION OF THE DRAWINGS

The foregoing and additional features and characteristics of the present invention will become more apparent from the following detailed description considered with reference to the accompanying drawing figures in which like reference numerals designate like elements.

FIG. 1 represents a schematic diagram illustrating a fuel cell electric power generation system according to a first example;

FIG. 2 represents a schematic diagram illustrating a reforming apparatus according to the first example;

FIG. 3 represents a schematic diagram illustrating a catalytic combustion portion (warming-up portion);

FIG. 4 represents a schematic diagram illustrating the catalytic combustion portion seen from a different viewpoint;

FIG. 5 represents a schematic diagram illustrating a fuel cell electric power generation system according to a second example;

FIG. 6 represents a schematic diagram illustrating a reforming apparatus according to the second example;

FIG. 7 represents a graph illustrating a relation between combustible range and adiabatic flame temperature, and illustrating a condition of transition from ignition operation to increasing-operation;

FIG. 8 represents a flowchart illustrating an example of operations performed by a catalytic combustion control portion according to the second example;

FIG. 9 represents a schematic diagram illustrating a reforming apparatus according to a third example;

FIG. 10 represents a schematic diagram illustrating a reforming apparatus according to a fourth example;

FIG. 11 represents a flowchart illustrating an example of operations performed by a catalytic combustion control portion according to the fourth example;

FIG. 12 represents a flowchart illustrating an example of operations performed by a catalytic combustion control portion according to a fifth example;

FIG. 13 represents a graph illustrating a change of flow rate of a reformed gas introduced to a warming-up portion at the time of warming-up operation;

FIG. 14 represents a schematic diagram illustrating a fuel cell electric power generation system according to a seventh example;

FIG. 15 represents a schematic diagram illustrating a reforming apparatus according to the seventh example;

FIG. 16 represents a schematic diagram illustrating a reforming apparatus according to an eighth example;

FIG. 17 represents a schematic diagram illustrating a reforming apparatus according to a ninth example;

FIG. 18 represents a schematic diagram illustrating a warming-up portion according to a tenth example;

FIG. 19 represents a schematic diagram illustrating a main body of the warming-up portion at which a heater is provided according to the tenth example;

FIG. 20 represents a schematic diagram illustrating a main body of a warming-up portion at which a heater is provided according to an eleventh example;

FIG. 21 represents a schematic diagram illustrating a warming-up portion according to a twelfth example;

FIG. 22 represents a schematic diagram illustrating a warming-up portion according to a thirteenth example;

FIG. 23 represents a schematic diagram illustrating a warming-up portion according to a fourteenth example;

FIG. 24 represents a schematic diagram illustrating a warming-up portion according to a fifteenth example; and

FIG. 25 represents a schematic diagram illustrating a warming-up portion according to a sixteenth example.

### BEST MODE FOR CARRYING OUT THE INVENTION

An embodiment of the present invention will be explained. A fuel gas processing apparatus includes a gas supply portion for supplying a fuel gas in which carbon monoxide is contained in some cases, a catalytic combustion portion for catalytically oxidizing the fuel gas, and a carbon monoxide reduction portion. The fuel gas can contain hydrogen as a main component (for example, 10 mol % or higher) and carbon monoxide. Hydrogen has small specific gravity and viscosity, high diffusion coefficient. Further, hydrogen has good ignitionability and combustibility at low temperature. Furthermore, hydrogen has high combustion rate. Combustion of hydrogen produces water. The carbon monoxide reduction portion reduces the amount of carbon monoxide contained in the fuel gas to purify the fuel gas before the fuel gas is supplied to the catalytic combustion portion. By doing so, ignitionability in the catalytic combustion portion can be enhanced.

The carbon monoxide reduction portion lowers a concentration of carbon monoxide (CO) contained in the fuel gas. The carbon monoxide reduction portion can have a first CO reduction portion for lowering a concentration of carbon monoxide contained in the fuel gas and a second CO reduction portion for further lowering a concentration of carbon monoxide contained in the fuel gas. One of the first CO reduction portion and the second CO reduction portion can employ a method for reducing CO by reaction of CO with water (H₂O). The other of the first CO reduction portion and the second CO reduction portion can employ a method for reducing CO by reaction of CO with oxygen (O₂).

The catalytic combustion portion can be provided at upstream side of the carbon reduction portion for warming-up of the carbon monoxide reduction portion. In this configuration, the carbon monoxide reduction portion can be warmed. Accordingly, this configuration is advantageous for the carbon monoxide reduction portion to become within an active temperature range early at the time of startup. The catalytic combustion portion is provided so as to communicate with the gas supply portion. In the catalytic combustion portion, a catalyst for catalytically oxidizing and combusting the fuel gas is supported. Catalytic combustion is a combustion in which a component of the fuel gas reacts with oxygen under a circumstance that a catalyst is present. In many cases, catalytic combustion is combustion without generating flame (in some cases, combustion with generation of flame). Comparing with normal combustion without use of catalysts, combustion start temperature and combustion temperature are lower because catalytic combustion is possible under conditions of low air-fuel ratio. In addition, even in a circumstance that a composition of gas changes, ignitionability and combustibility can be stable. In the meantime, combustion without generating flame means an oxidation combustion in which flame cannot be visually seen in substance. As a usable catalyst, at least one of platinum-group metals such as platinum, rhodium, palladium, ruthenium, iridium, and osmium, or, metal oxides containing a metal such as nickel, cobalt, iron, manganese, chromium, and silver can be exampled. A catalyst can be supported by a support. As a support, any of a pellet support and a monolith support can be employed. The catalytic combustion portion can have a function for warming-up of the carbon monoxide reduction portion.

The gas supply portion described above can include a main body of a reforming portion for reforming materials for reforming to produce a reformed gas as the fuel gas and a combustion portion for heating the main body of the reforming portion by combustion. In this case, the carbon monoxide reduction portion can be provided so that heat can be transmitted from the main body of the reforming portion and/or the combustion portion. By doing so, at the time of startup, the carbon monoxide reduction portion can become within an active temperature range early, which can contribute to lower a concentration of CO contained in the fuel gas.

According to the embodiment of the present invention, means for promoting activation, which promotes to shorten a time for a temperature of the carbon monoxide reduction portion to become within an active temperature range at the time of startup, can be provided. As the means for promoting activation, a heating portion such as an electric heater for directly, or indirectly heating the carbon monoxide reduction portion can be exampled. If an electric heater is employed, controllability can be preferable.

In addition, the means for promoting activation can include an exhausted combustion gas passage for supplying an exhausted combustion gas to the carbon reduction portion from the combustion portion in the reforming portion to heat the carbon monoxide reduction portion by heat of the exhausted combustion gas. At the time of startup, because the exhausted combustion gas of high temperature is exhausted from the combustion portion of the reforming portion to the exhausted combustion gas passage, the carbon monoxide reduction portion can be heated in short time. In this case, the carbon monoxide reduction portion can become within an active temperature range early at the time of startup, which can contribute to reduce a concentration of CO contained in the reformed gas. In addition, the means for promoting activation can supply oxygen to the carbon monoxide reduction portion at the time of startup. By doing so, carbon monoxide can react with oxygen, which can contribute to lower a concentration of CO of the reformed gas at the time of startup.

According to the embodiment of the present invention, the means for promoting activation can include an introducing means for introducing the fuel gas containing hydrogen and carbon monoxide to the catalytic combustion portion and an oxygen supplying means for supplying a gas containing oxygen as a main component (generally air) to the catalytic combustion portion before the fuel gas containing hydrogen and carbon monoxide is introduced to the catalytic combustion portion by the introducing means. In a condition that a gas containing oxygen as a main component is supplied to the catalytic combustion portion, when the fuel gas containing hydrogen and carbon monoxide is supplied to the catalytic combustion portion, even if the fuel gas contains carbon monoxide, ignitionability of the catalytic combustion portion can be easily ensured. Carbon monoxide tends to adhere to the catalyst in the catalytic combustion portion and to lower catalytic activity of the catalyst. However, if hydrogen having high combustibility presents together, the catalytic combustion portion can be more easily ignited because hydrogen can be combusted easily. In the meantime, it is assumed that following properties of hydrogen molecules lead to an easiness of combustion of the catalytic combustion portion: light weight, low viscosity, and high flow velocity. According to properties described above, hydrogen molecules can reach the catalytic combustion portion earlier than carbon monoxide molecules, and in turn, hydrogen-rich atmosphere can be temporally formed in the catalytic combustion portion.

According to the embodiment of the present invention, a catalytic combustion control portion for controlling catalytic combustion in the catalytic combustion portion can be provided. The catalytic combustion control portion can perform an ignition operation for igniting the catalytic combustion portion in a condition out of a combustible area in which a fuel gas and air are combusted with generation of flame and an increasing-operation for increasing, after the ignition operation, a flow rate of air supplied to the catalytic combustion portion from a flow rate of air at the time of the ignition operation. Ignition is a phenomenon in which oxidation combustion reaction starts and continues. It can be judged on the basis of temperature rise of the catalytic combustion portion whether the catalytic combustion portion is ignited or not. Because combustibility of catalytic combustion is good, even in a condition out of the combustible area, the catalytic combustion portion can be ignited. If a flow rate of air supplied to the catalytic combustion portion is increased after the catalytic combustion portion is ignited, stability of oxidative reaction in the catalytic combustion portion can be improved, and in turn, the generated amount of heat and temperature rise property in the catalytic combustion portion can be ensured. Accordingly, control of combustion in the catalytic combustion portion can be easy even in a case where CO, which tends to inhibit combustibility, is contained in the fuel gas, or, even in a case where a ratio between the amount of combustible component and air in the fuel gas, in other words, air-fuel ratio, changes, or, even in a case where the temperature of the catalyst is low, or, even in a case where moisture such as water vapor and water droplets are contained in the fuel gas.

According to the embodiment of the present invention, the fuel gas processing apparatus can be applied to a reforming apparatus. The reforming apparatus includes a reforming portion for reforming materials for reforming to produce a reformed gas and a reformed gas purification portion provided so as to communicate with the reforming portion for purifying the reformed gas produced in the reforming portion. The reformed gas purification portion has a function for purifying the reformed gas produced in the reforming portion. The reformed gas purification portion can include an impurity reduction portion for reducing the amount of impurity (for example, carbon monoxide) contained in the reformed gas. Further, the impurity reduction portion can include a separation membrane for separating carbon monoxide from the reformed gas. Further, the impurity reduction portion can include a CO reduction portion for reducing the amount of CO contained in the reformed gas. Anything can be the CO reduction portion if it has a function for lowering a concentration of CO contained in the reformed gas. The CO reduction portion can have a first CO reduction portion for lowering a concentration of carbon monoxide contained in the reformed gas and a second CO reduction portion for further lowering a concentration of carbon monoxide contained in the reformed gas. One of the first CO reduction portion and the second CO reduction portion can employ a method for reducing the amount of CO by reaction of CO with H₂O. The other of the first CO reduction portion and the second CO reduction portion can employ a method for reducing the amount of CO by reaction of CO with O₂. Further, the CO reduction portion can employ a method for reducing the amount of carbon monoxide by reaction of carbon monoxide with hydrogen to produce methane, in other words, methanation reaction.

A warming-up portion includes a main body having a function for warming-up of the reformed gas purification portion at the time of startup of the reforming portion. The reformed gas produced in the reforming portion can be introduced to the main body of the warming-up portion to be combusted in order for warming-up of the reformed gas purification portion at the time of startup.

The main body of the warming-up portion can be the catalytic combustion portion including a catalyst for catalytic combustion.

Means for promoting temperature rise promotes a temperature rise property of the main body of the warming-up portion at the time of startup of the reforming portion. The means for promoting temperature rise can include a providing means for providing the main body of the warming-up portion in a flow passage in which the reformed gas produced in the reforming portion flow toward the reformed gas purification portion downstream of the reforming portion and upstream of the reformed gas purification portion. In this case, the warming-up portion can be heated by the reformed gas produced in the reforming portion early. Accordingly, a temperature of the warming-up portion at the time of startup can rise early, and a temperature of the reformed gas purification portion can rise early.

The means for promoting temperature rise can limit introduction of the reformed gas to the warming-up portion at the time of startup under the condition that a temperature of the main body of the warming-up portion or the main body of the reforming portion is under normal temperature, and after that, increase a flow rate of the reformed gas introduced to the warming-up portion as the temperature of the main body of the warming-up portion rises. At the time of startup, a concentration of impurity such as CO contained in the reformed gas produced in the reforming portion is generally higher than that in the normal operation. If impurity such as CO adheres to the main body of the warming-up portion, the temperature of the warming-up portion tends to become impossible to rise early. For preventing this, at the time of startup, introduction of the reformed gas to the warming-up portion is limited. Then, as the temperature of the main body of the warming-up portion rises, the flow rate of the reformed gas introduced to the warming-up portion is increased. In the meantime, “to limit introduction of the reformed gas to the warming-up portion” represents to prevent introduce of the reformed gas to the warming-up portion, or to introduce the reformed gas to the warming-up portion in a small amount.

Further example of the means for promoting temperature rise of the warming-up portion will be explained. The means for promoting temperature rise of the warming-up portion can include a providing means for providing the main body of the warming-up portion so that heat can be transmitted from the reforming portion to the main body of the warming-up portion. In this case, the main body of the warming-up portion can be heated early by heat transmitted from the reforming portion heated to high temperature. Accordingly, possibility of temperature rise of the warming-up portion at the time of startup can be enhanced.

Still further example of the means for promoting temperature rise of the warming-up portion will be explained. The means for promoting temperature rise of the warming-up portion can include a heater for heating the main body of the warming-up portion. In this case, the heater can include an embedded heating portion embedded in the main body of the warming-up portion. In this case, the embedded heating portion can function as an ignition portion for combustion. Accordingly, earliness of the temperature rise of the warming-up portion at the time of startup can be enhanced. The heater can include an electric heater. Alternatively, the heater can be provided outside the main body of the warming-up portion. In this case, possibility of temperature rise of entire main body of the warming-up portion at the time of startup can be enhanced.

The reforming apparatus can include a cooling portion provided between the reforming portion and the warming-up portion. The cooling portion cools the reformed gas of high temperature reformed in the reforming portion before the reformed gas is supplied to the warming-up portion. The cooling portion can have a heat-exchange function for cooling the reformed gas reformed in the reforming portion to be supplied to the warming-up portion and for heating a material for reforming to be supplied to the reforming portion, reforming water for reforming the material for reforming, and air (in the case of autothermal type).

According to the embodiment of the present invention, moisture reduction means can include a gas contact member for capturing moisture contained in the reformed gas when the reformed gas supplied to the warming-up portion contacts with a contact portion of the gas contact member. The gas contact member can include a collision member with which the reformed gas collides. The collision member can include a plate member, a meshed member, and a porous member.

When the reformed gas contacts with the contact portion, the reformed gas having merged with air can contact with the contact portion. Alternatively, the reformed gas can contact with the contact portion before the reformed gas merges with air.

According to the embodiment of the present invention, an upstream moisture storage portion can be provided in a flow passage in which the reformed gas flows through the moisture reduction means at the time of startup and upstream of the main body of the warming-up portion. The upstream moisture storage portion stores moisture captured from the reformed gas supplied to the main body of the warming-up portion. A level of a bottom surface of the upstream moisture storage portion can be set lower than the main body of the warming-up portion. By doing so, moisture stored in the upstream moisture storage portion can be inhibited from entering the main body of the warming-up portion.

According to the embodiment of the present invention, a downstream moisture storage portion can be provided in a flow passage in which the reformed gas flows through the moisture reduction means at the time of startup and downstream of the main body of the warming-up portion. The downstream moisture storage portion stores moisture. A level of a bottom surface of the downstream moisture storage portion can be set lower than the main body of the warming-up portion. By doing so, moisture stored in the downstream moisture storage portion can be inhibited from entering the main body of the warming-up portion.

According to the embodiment of the present invention, the moisture reduction means can include a blowing means for blowing a gas other than the reformed gas (generally air) at the time of ending reforming operation in the reforming portion. By doing so, moisture exist in the warming-up portion can be carried away and separated from the warming-up portion. The gas can be blown when the temperature of the main body of the warming-up portion is high. By doing so, moisture can vaporize and easily carried away. In addition, remaining reformed gas exist in the warming-up portion, or CO component adhering to the warming-up portion can be carried away from the warming-up portion. This blowing can be performed for, for example, 1 minute to 20 minutes. However, it is not limited.

If a temperature of the warming-up portion is 100° C. or less at the time of startup of the reforming portion, the moisture reduction means can be formed by forming a meandering flow passage connected to the warming-up portion in a flow passage in which the reformed gas flows through the moisture reduction means and upstream of the main body of the warming-up portion. In this case, the reformed gas flowing toward the warming-up portion flows along the meandering flow passage. At this time, frequency of the reformed gas colliding with an inner wall surface of the meandering flow passage increases. Accordingly, moisture contained in the reformed gas can be advantageously reduced.

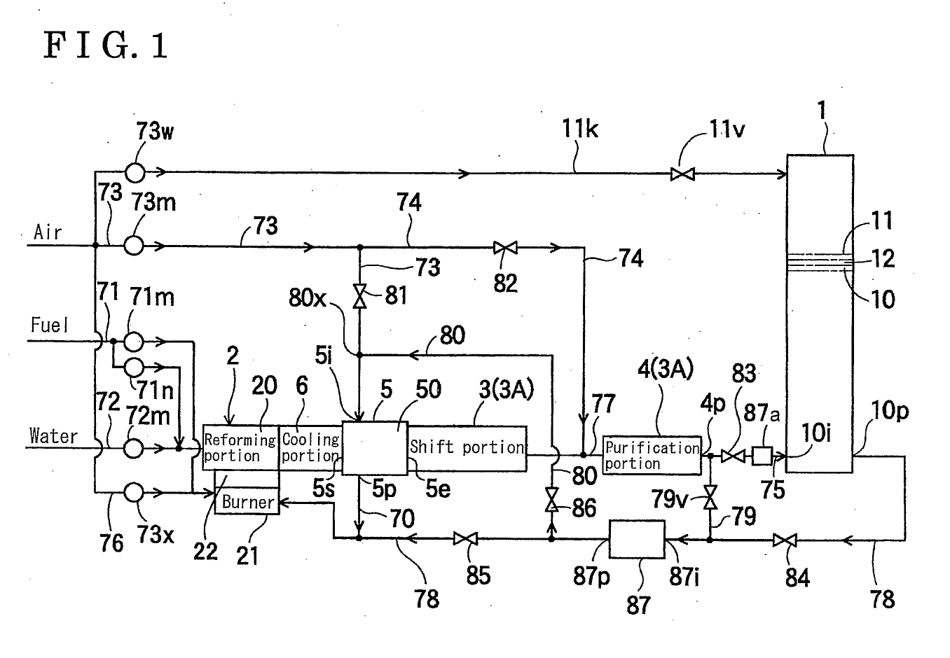

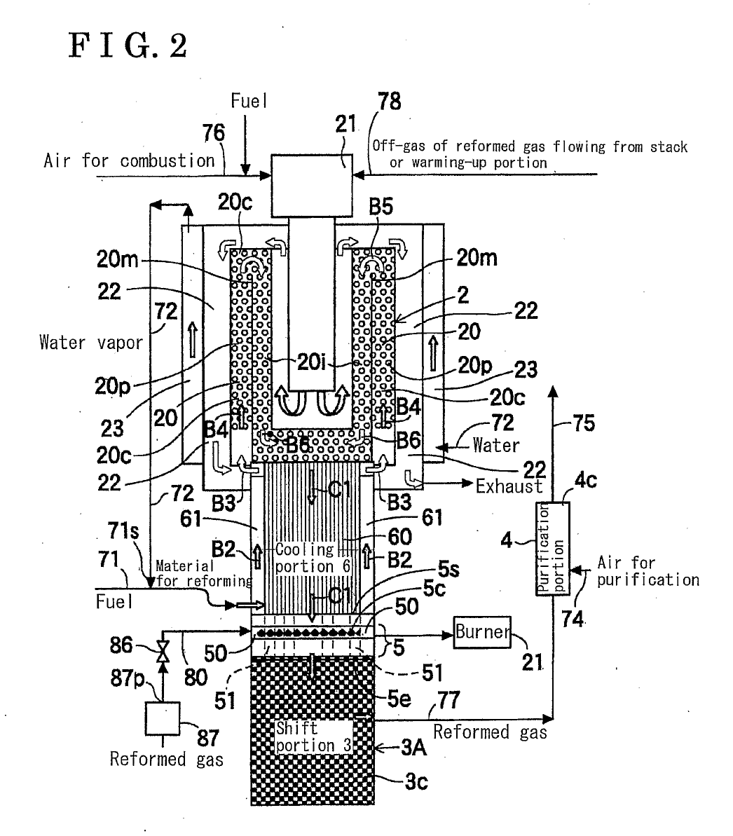

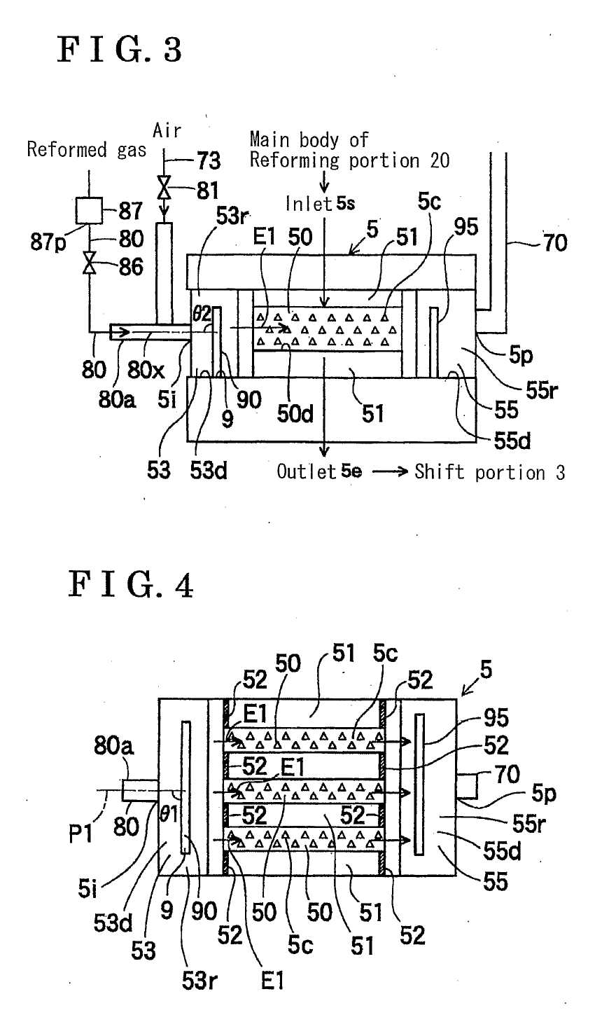

A first example of the present invention will be explained with reference to drawing figures. A reforming apparatus according to the first example is applied to a fuel cell electric power generation system. FIG. 1 represents a diagram illustrating a system of the reforming apparatus. FIG. 2 represents a schematic diagram illustrating the reforming apparatus. FIGS. 3 and 4 represent diagrams each illustrating a catalytic combustion portion. As illustrated in FIG. 1, a fuel cell stack 1, in which fuel cells are stacked, is provided. The fuel cell includes a fuel electrode 10 to which a reformed gas (fuel gas) is supplied, an oxidizing agent electrode 11 to which gas containing oxygen as an oxidizing agent is supplied, and an electrolytic membrane 12 sandwiched between the fuel electrode 10 and the oxidizing agent electrode 11.

A fuel gas processing apparatus includes a reforming portion (gas supply portion) 2 for producing a reformed gas (fuel gas) containing hydrogen as a main component by reforming a material for reforming by means of steam reforming and a carbon monoxide reduction portion 3A for reducing the amount of carbon monoxide, as an impurity, contained in the reformed gas produced in the reforming portion 2. The material for reforming includes a fuel and water. The fuel is, for example, town gas, liquefied petroleum gas (LPG), coal oil, hydrocarbon fuel such as diethyl ether, or alcohol fuel such as methanol.

As illustrated in FIG. 2, the reforming portion 2 includes a main body 20 of the reforming portion 2 including a reforming catalyst 20c for promoting reforming reaction, a burner 21 to which the fuel and air are supplied, a cylindrical combustion zone 22 in which the fuel is combusted, the combustion zone 22 having a ring cross section, and a cylindrical vaporization portion 23 for vaporizing water utilizing heat transmitted from the combustion zone 22. The burner 21 and the combustion zone 22 configure a combustion portion. Heat is transmitted from the combustion zone 22 to the main body 20 of the reforming portion 2 and the vaporization portion 23. An active temperature range of the reforming catalyst 20c provided in the main body 20 of the reforming portion 2 is generally from 500° C. to 800° C. However, it is not limited.

As illustrated in FIG. 2, the fuel and air for combustion are supplied to the burner 21. Combustion of the fuel heats the main body 20 of the reforming portion 2 into a high temperature range. In the main body 20 of the reforming portion 2, steam reforming is performed in which each of materials for reforming (the fuel and water) reacts with other according to reaction formula 1 described below, and a reformed gas, containing hydrogen as a main component, is produced as a fuel gas. In the reformed gas produced in the main body 20 of the reforming portion 2, carbon monoxide (CO) is produced as a byproduct. In this case, a concentration of CO is generally 5 to 15%. However, it is not limited. In the meantime, the concentration of CO is described in terms of mole percent.

As illustrated in FIG. 1, the carbon monoxide reduction portion 3A is provided downstream of the reforming portion 2 so that heat can be transmitted thereto from the reforming portion 2. The carbon monoxide reduction portion 3A includes a shift portion (a reformed gas purification portion) 3 serving as a first carbon monoxide (CO) reduction portion and a purification portion (a reformed gas purification portion) 4 serving as a second carbon monoxide (CO) reduction portion. The shift portion 3 includes a shifting catalyst 3c for promoting shift reaction according to reaction formula 2 described below. An active temperature range of the shifting catalyst 3c is generally from 200 to 300° C. However, it is not limited. A main component of the shifting catalyst 3c is, for example, copper-zinc. However, it is not limited.

The purification portion 4 includes a purifying catalyst 4c (for example, a ruthenium type). The purifying catalyst 4c promotes oxidative reaction of CO into carbon dioxide according to reaction formula 3 described below. As a result of the oxidative reaction, the amount of CO is reduced. The purification portion 4 further includes a ceramic support (for example, an alumina type) for supporting the purifying catalyst 4c. An active temperature range of the purifying catalyst 4c is generally 100 to 200° C. However, it is not limited. A concentration of CO contained in the reformed gas purified in the shift portion 3 is generally 0.2 to 1%. However, it is not limited. A concentration of CO contained in the reformed gas purified in the purification portion 4 is generally 10 ppm or less. However, it is not limited.

CH₄+H₂O.3H₂+CO Reaction formula 1

CO+H₂O.H₂+CO₂ Reaction formula 2

CO+½O₂.CO₂ Reaction formula 3

As illustrated in FIG. 1, a catalytic combustion portion (warming-up portion) 5 is provided between the shift portion 3 and the reforming portion 2. In the catalytic combustion portion 5, oxidative reaction is performed by use of a catalyst. The catalytic combustion portion 5 includes an inlet 5s communicating with the reforming portion 2 and an outlet 5e communicating with the shift portion 3. The catalytic combustion portion 5 is provided downstream of the reforming portion 2 and upstream of the shift portion 3 so that a temperature of the shift portion 3 can easily rise. Precisely, the catalytic combustion portion 5 is provided adjacent to the shift portion 3. In other words, a main body 50 of the catalytic combustion portion 5 is provided in a flow passage, in which the reformed gas produced in the reforming portion 2 at the time of startup flows toward the shift portion 3, downstream of the reforming portion 2 and upstream of the shift portion 3. The catalytic combustion portion 5 configured as above serves as a means for promoting temperature rise of the main body of the catalytic combustion portion.

At the time of startup, the reformed gas (fuel gas) produced in the reforming portion 2 is introduced to a warming-up inlet 5i of the main body 50 of the catalytic combustion portion 5. Thus, in the main body 50 of the catalytic combustion portion 5, the reformed gas is combusted for warming-up of the shift portion 3 (object to be warmed up) with use of the combustion heat at the time of startup. In the shift portion 3 which is warmed up, a reaction, in which the amount of carbon monoxide contained in the reformed gas is reduced, is promoted.

FIGS. 3 and 4 represent schematic diagrams each illustrating the catalytic combustion portion 5, having a catalytic combustion function, described above. The catalytic combustion portion 5 includes a catalyst 5c (for example, Pt—Pd type) for catalytic combustion. Precisely, the catalytic combustion portion 5 includes plural main bodies 50 of the catalytic combustion portion 5 each including a ceramic support (for example, alumina) which supports the catalyst 5c, plural reformed gas passages 51, and a sealing portion 52 for sealing the reformed gas passages 51. The main body 50 of the catalytic combustion portion 5 has gas permeability. Accordingly, the reformed gas (reformed and refluxed gas) can be combusted in and simultaneously permeate through the main body 50 of the catalytic combustion portion 5. The support for supporting the catalyst 5c can be any of a pellet type and a monolith type. As described above, in the catalytic combustion, the fuel gas and oxygen react each other and the fuel gas is oxidized. The catalytic combustion is generally a combustion without generating flame (in some cases, a combustion with generation of flame). The catalytic combustion is, comparing with a normal combustion without use of a combustion catalyst, more stable and has a lower combustion temperature.

As illustrated in FIG. 3, the inlet 5s of the catalytic combustion portion 5 at one end side of the reformed gas passage 51 communicates with the main body 20 of the reforming portion 2. The outlet 5e of the catalytic combustion portion 5 at the other end side of the reformed gas passage 51 communicates with the shift portion 3. Accordingly, in the catalytic combustion portion 5, the reformed gas produced in the main body 20 of the reforming portion 2 passes the inlet 5s, the reformed gas passage 51, and the outlet 5e, and flows toward the shift portion 3. As illustrated in FIG. 4, in the catalytic combustion portion 5, the main body 50 of the catalytic combustion portion 5 and the reformed gas passage 51 faces each other. Accordingly, a rate of temperature rise at the main body 50 of the catalytic combustion portion 5 at the time of startup can be enhanced by effect of the reformed gas of high temperature which passes through the reformed gas passage 51.

According to the example, as illustrated in FIG. 1, a cooling portion 6 is provided between the reforming portion 2 and the catalytic combustion portion 5. In the cooling portion 6, the reformed gas reformed in the reforming portion 2 of high temperature is cooled before the reformed gas is supplied to the catalytic combustion portion 5. Here, as illustrated in FIG. 2, the cooling portion 6 includes a gas passage 60 for supplying the reformed gas reformed in the main body 20 of the reforming portion 2 toward the reformed gas passage 51 of the catalytic combustion portion 5 and a material passage 61 through which materials for reforming (the fuel and water) passes before the materials for reforming are supplied to the main body 20 of the reforming portion 2. As a result, the reformed gas passing through the gas passage 60 can be cooled and the materials for reforming passing through the material passage 61 can be heated. Accordingly, the cooling portion 6 can serve as a heat exchange portion in which heat is exchanged between the materials for reforming of lower temperature before the materials are supplied to the reforming portion 2 and the reformed gas of higher temperature flowing out from the reforming portion 2.

Piping configuration will be further explained with reference to FIG. 1. A first passage 71 is provided for supplying the fuel as a material for reforming to the burner 21 or the main body 20 of the reforming portion 2. In the first passage 71, conveying elements 71m and 71n, such as a pump, are provided for conveying the fuel. Further, a second passage 72 is provided for supplying water as a material for reforming to the main body 20 of the reforming portion 2. In the second passage 72, a conveying element 72m, such as a pump, is provided for conveying the water-related material to the reforming portion 2. A third passage 73 is provided for supplying air (gas containing oxygen) to the warming-up inlet 5i of the catalytic combustion portion 5 through a first valve 81 (first opening/closing means). In the third passage 73, a conveying element 73m, such as a fan, a compressor, a blower, or a pump, is provided for conveying air. Further, an air passage 76 is provided for supplying air to the burner 21. The air passage 76 communicates with the third passage 73. In the air passage 76, a conveying element 73x is provided. An oxidizing agent passage 11k is provided for supplying air to the oxidizing agent electrode 11 of the fuel cell stack 1. The oxidizing agent passage 11k communicates with the third passage 73. In the oxidizing agent passage 11k, a conveying element 73w is provided.

As illustrated in FIG. 1, a fourth passage 74 is provided for supplying air for purification to the purification portion 4 through a second valve 82 (second opening/closing means). A connection passage 77 is provided for connecting the shift portion 3 with the purification portion 4. A fifth passage 75 is provided for connecting an outlet 4p side of the purification portion 4 with an inlet 10i side of the fuel electrode 10 of the fuel cell stack 1 through a third valve 83 (third opening/closing means) and a condenser 87a. A first return passage 78 is provided for connecting an outlet 10p side of the fuel electrode 10 of the fuel cell stack 1 with the burner 21 of the reforming portion 2. In the first return passage 78, a fourth valve 84 (fourth opening/closing means), a condenser 87, a fifth valve 85 (fifth opening/closing means) are provided in series in an order described above from the fuel cell stack 1 to the burner 21.

As illustrated in FIG. 1, a first bypass passage 79 is provided for connecting the outlet 4p side of the purification portion 4 with an inlet 87i side of the condenser 87 through a bypass valve 79v so as to bypass the fuel cell stack 1. Further, a second bypass passage 80 is provided for connecting an outlet 87p side of the condenser 87 with the warming-up inlet 5i side of the catalytic combustion portion 5 through a sixth valve 86 (sixth opening/closing means). The second bypass passage 80 in which the reformed gas flows merges with the third passage 73 in which air flows at a merging portion 80x. A second return passage 70 is provided for connecting the warming-up outlet 5p side of the catalytic combustion portion 5 with the burner 21.

Further explanation will be made with reference to FIG. 2. As illustrated in FIG. 2, the main body 20 of the reforming portion 2 includes an inner portion 20i, an outer portion 20p, and a turning portion 20m. Then, at the time of startup of the fuel cell system, in other words, at the time of startup of the reforming portion 2, the fuel and air for combustion are supplied to the burner 21, the burner 21 is ignited, and the fuel is combusted in the reforming portion 2. Accordingly, the main body 20 of the reforming portion 2 and the vaporization portion 23 are gradually heated. Heat is slowly transmitted from the reforming portion 2 to the shift portion 3 and the purification portion 4. Accordingly, at the time of startup, a long duration of time (for example, from 30 minutes to 90 minutes) is required for raising a temperature of the shift portion 3 and a temperature of the purification portion 4 to each active temperature range.

Thus, in a state where a temperature of the reforming portion 2 is high, the fuel and water are supplied to the main body 20 of the reforming portion 2. In this case, water is vaporized as the water passes through the vaporization portion 23. The vapor and the fuel merge in a merging area 71s, flow along a direction indicated by arrows B2 and B3 through the material passage 61 of the cooling portion 6, and supplied to the outer portion 20p of the main body 20 of the reforming portion 2. Thus, the materials for reforming are heated in advance while the materials for reforming pass through the material passage 61 of the cooling portion 6.

In FIG. 2, the materials for reforming described above flow into the outer portion 20p of the main body 20 of the reforming portion 2, flows in the outer portion 20p in a direction indicated by an arrow B4, turn in the turning portion 20m of the main body 20 of the reforming portion 2 in a direction indicated an arrow B5, and flows in the inner portion 20i of the main body 20 of the reforming portion 2 in a direction indicated by an arrow B6. Thus, the materials for reforming are processed by steam reforming as the materials for reforming pass through inside the main body 20 of the reforming portion 2 whereby the reformed gas is generated. The generated reformed gas flows in the gas passage 60 of the cooling portion 6 in a direction of an arrow C1, and reaches the shift portion 3 through the reformed gas passage 51 of the catalytic combustion portion 5.

Here, according to this example, steam reforming is performed according to reaction formula 1 described above and the reformed gas is generated. The reformed gas is hydrogen-rich but contains CO. In the shift portion 3, the amount of CO contained in the reformed gas is reduced according to a shift reaction described in reaction formula 2 described above. In the purification portion 4, CO contained in the reformed gas is further reduced according to reaction formula 3 described above. Accordingly, CO contained in the reformed gas is reduced so that the reformed gas can be suitable for an electricity-generating reaction performed in the fuel cell stack 1.

In the meantime, at the time of startup, a temperature of the main body 20 of the reforming portion 2 is low, CO concentration of the reformed gas generated in the main body 20 of the reforming portion 2 is high, and a temperature of the shift portion 3 is low. Accordingly, the temperature of the shift portion 3 does not reach within the active temperature range. Accordingly, effect of CO reduction obtainable by the shift portion 3 is limited and not always sufficient for utilizing the reformed gas in electric power generation of the fuel cell stack 1. According to this example, at the time of startup, the reformed gas is not supplied to the fuel cell stack 1. The reformed gas bypasses the fuel cell stack 1. In other words, as illustrated in FIG. 1, the reformed gas having passed the purification portion 4 is supplied to the inlet 87i of the condenser 87 through the bypass valve 79v and the first bypass passage 79. The reformed gas is cooled in the condenser 87. At this time, moisture contained in the reformed gas is condensed and the amount of moisture contained in the reformed gas is reduced.

Then, the reformed gas, of which moisture is reduced in the condenser 87, is introduced to the warming-up inlet 5i of the catalytic combustion portion 5 through the outlet 87p of the condenser 87, the sixth valve 86, and the second bypass passage 80. At this time, the first valve 81 is opened for introducing air for catalytic combustion to the warming-up inlet 5i of the catalytic combustion portion 5 through the first valve 81. In the meantime, the reformed gas and air merge at a merging portion 80x before the reformed gas and air are introduced to the warming-up inlet 5i of the warming-up portion 5. However, it is not limited. The reformed gas introduced to the warming-up inlet 5i of the catalytic combustion portion 5 (containing hydrogen as a main component, which excels in a combustibility at a low temperature) passes through an inner portion of the main body 50 of the catalytic combustion portion 5 in a direction indicated by an arrow E1 (illustrated in FIG. 4) together with air introduced to the warming-up inlet 5i of the catalytic combustion portion 5, and is catalytically combusted in the main body 50 of the catalytic combustion portion 5 with use of the catalyst 5c. Accordingly, the temperature of the main body 50 of the warming-up portion (catalytic combustion portion) 5 can rise earlier than a case where the main body 50 of the warming-up portion (catalytic combustion portion) 5 is not catalytically combusted. As a result, at the time of startup, the temperature of the shift portion 3 can rise by effect of the catalytic combustion portion 5.

An off-gas after catalytically combusted in the catalytic combustion portion 5 flows downstream from the warming-up outlet 5p of the catalytic combustion portion 5, and flows to the burner 21 through the second return passage 70 and the first return passage 78. There can be a possibility that the off-gas contains hydrogen as a combustible component. The combustible component is combusted by the burner 21. After that, the off-gas is exhausted.

As described above, at the time of warming-up operation for heating the catalytic combustion portion 5 by effect of catalytic combustion, the third valve 83 and the fourth valve 84 are closed. The bypass valve 79v, the first valve 81, and the sixth valve 86 are opened. In the meantime, as described above, at the time of warming-up operation, the second valve 82 is generally closed. However, as a required basis, the second valve 82; can be opened for supplying air to the purification portion 4.

After a predetermined duration of time passes from the time of startup, the main body 20 of the reforming portion 2 is heated, at least a part of the shift portion 3 is heated, and an effect of CO reduction in the shift portion 3 can be substantially increased. Accordingly, a mode of operation of the fuel cell system can be transferred to a normal operation from a warming-up operation. In the normal operation, the third valve 83, the fourth valve 84, the fifth valve 85, and the second valve 82 are opened, and the bypass valve 79v, the sixth valve 86, and the first valve 81 are closed. Thus, the first bypass passage 79 and the second bypass passage 80 are closed. Accordingly, in the normal operation, the reformed gas processed by steam reforming in the main body 20 of the reforming portion 2 is supplied to the inlet 10i of the fuel electrode 10 of the fuel cell stack 1 through the cooling portion 6, the reformed gas passage 51 of the catalytic combustion portion 5, the shift portion 3, the connection passage 77, the purification portion 4, the third valve 83, and the fifth passage 75 in an order described above. Further, in the normal operation, air as an oxidizing agent gas is supplied to the oxidizing agent electrode 11 of the fuel cell stack 1 through a valve 11v of the oxidizing agent passage 11k. Thus, in the fuel cell stack 1, electricity-generating reaction is performed and electric energy is generated. An off-gas, the reformed gas having been utilized in the electric power generation, is supplied to the burner 21 from the outlet 10p side of the fuel electrode 10 of the fuel cell stack 1 through the first return passage 78, the condenser 87, and the fifth valve 85. Because there can be a possibility that the off-gas, the reformed gas having been utilized in the electric power generation, contains hydrogen as a combustible component, the combustible component is combusted in the burner 21. After that, the off-gas is exhausted.

At the time of startup of the fuel gas processing apparatus, because the temperature of the main body of the warming-up portion 5 is low, a function of the warming-up portion 5 for warming-up of the shift portion 3 is not always sufficient. According to this example, at the time of startup of the fuel gas processing apparatus, the reformed gas is supplied to the main body 50 of the warming-up portion 5 and catalytically combusted in the main body 50 to warm the warming-up portion 5 early. In the meantime, when the temperature of the catalytic combustion portion 5 rises as described above, the reformed gas supplied to the warming-up inlet 5i of the main body 50 of the catalytic combustion portion 5 contains moisture in many cases. This is because the reformed gas has been processed by steam reforming. If a mole ratio between supplied water (H₂O) component and carbon (C) component contained in the fuel is equal to a mole ratio between H₂O and C in the reforming reaction (steam carbon ratio, S/C) indicated by reaction formula 1, carbon tends to precipitate from the fuel, which tends to degrade performance and durability of catalyst. For overcoming this, generally, water is excessively supplied, for example, according to S/C=3. Accordingly, there can be a possibility that the reformed gas contains moisture corresponding to a saturated vapor pressure. Further, because the reformed gas is cooled as the reformed gas flows in the second bypass passage 80 from the condenser 87 toward the catalytic combustion portion 5, there can be a possibility that the reformed gas supplied to the warming-up inlet 5i of the catalytic combustion portion 5 contains moisture in a state of water droplet.

Here, according to this example, as illustrated in FIGS. 3 and 4, in the catalytic combustion portion 5 at the warming-up inlet 5i side of the main body 50 of the catalytic combustion portion 5, a first gas contact member 9 is provided. Here, the warming-up inlet 5i of the main body 50 of the catalytic combustion portion 5 is provided in a flow passage through which the reformed gas flows through the first gas contact member 9 (moisture reduction means) at the time of startup upstream of the main body 50 of the catalytic combustion portion 5. Further, the warming-up outlet 5p of the main body 50 of the catalytic combustion portion 5 is provided in the flow passage through which the reformed gas flows through the first gas contact member 9 (moisture reduction means) downstream of the main body 50 of the catalytic combustion portion 5.

As illustrated in FIGS. 3 and 4, the first gas contact member 9 includes a contact portion 90 with which the reformed gas supplied to the main body 50 of the catalytic combustion portion 5 collides and contacts at the time of warming-up operation. The first gas contact member 9 is formed as a plate so as to have a function of a baffle. The first gas contact member 9 faces a passage portion 80a of the second bypass passage 80 through which the reformed gas supplied from the outlet 87p of the condenser 87 through the second bypass passage 80 flows. The passage portion 80a is connected to the warming-up inlet 5i of the catalytic combustion portion 5. Precisely, as illustrated in FIG. 4, the first gas contact member 9 is provided approximately in a direction that crosses an axis line P1 of the passage portion 80a of the second bypass passage 80. In other words, the first gas contact member 9 is provided approximately in a direction vertical to the axis line P1 of the passage portion 80a of the second bypass passage 80.

Accordingly, as described above, at the time of startup of the reforming apparatus, in other words, at the time of warming-up operation in which the temperature of the catalytic combustion portion 5 rises, the reformed gas introduced to the warming-up inlet 5i of the catalytic combustion portion 5 collides with the contact portion 90 of the first gas contact member 9. Accordingly, moisture (water vapor, water droplet, or the like) contained in the reformed gas is captured by the contact portion 90 of the first gas contact member 9 and removed from the reformed gas. In particular, according to this example, because the collision angles °1 and °2 at which the reformed gas contacts with the contact portion 90 of the first gas contact member 9 are 90° or near 90°, possibility of collision is high. This high collision possibility is advantageous for capturing water droplets contained in the reformed gas. When the reformed gas contains saturated water vapor, liquefaction can easily progress through shock of the collision. In this example, the first gas contact member 9 can function as a moisture reduction means for restraining moisture contained in the reformed gas from adhering to the main body 50 of the catalytic combustion portion 5 at the time of startup.

According to this example described above, at the time of startup, moisture (water vapor, water droplet, or the like) can be restrained from adhering to the main body 50 of the catalytic combustion portion 5, in particular, a reaction site of the catalyst 5c included in the main body 50 of the catalytic combustion portion 5. Accordingly, at the time of startup, ignitionability, combustibility, temperature rise property for the main body 50 of the catalytic combustion portion 5 in which catalytic combustion is performed can be further enhanced. In other words, catalytic combustion can be early started in the main body 50 of the catalytic combustion portion 5 and the temperature of the main body 50 of the catalytic combustion portion 5 can rise early. As a result, the temperature of the shift portion 3 can rise early and the shift portion 3 can start operation early. Further, in the catalytic combustion portion 5, the first gas contact member 9 has a function for separately distributing the reformed gas to the plural reformed gas passages 51.

At the time of startup, the temperature T1 of the reformed gas flowing into the warming-up inlet 5i of the warming-up portion 5 (catalytic combustion portion) through the second bypass passage 80 and the temperature T2 of air flowing into the warming-up inlet 5i of the warming-up portion 5 through the third passage 73 and the first valve 81 can satisfy any condition as follows, T1.T2, T1.T2, T1.T2, T1.T2.

In the meantime, when T1 is higher than T2, the temperature of the reformed gas higher than that of air can be lowered by air. By effect of this temperature lowering, it can be expected that water vapor contained in the reformed gas is condensed and the amount of moisture contained in the reformed gas is lowered before the reformed gas is introduced to the warming-up portion 5. On the other hand, in a condition where the temperature of the reformed gas flowing from the condenser 87 is excessively low, if a temperature condition is made that T1 is lower than T2, the reformed gas can be warmed by air.

Further, according to this example, as illustrated in FIG. 3, an upstream moisture storage portion 53 is provided at the warming-up inlet 5i side of the catalytic combustion portion 5, in other words, upstream of the main body 50 of the catalytic combustion portion 5. The upstream moisture storage portion 53 includes a space 53r for storing moisture captured from the reformed gas supplied to the main body 50 of the catalytic combustion portion 5. The first gas contact member 9 is provided on a bottom surface 53d of the upstream moisture storage portion 53. A level of the bottom surface 53d of the upstream moisture storage portion 53 is set lower than that of a bottom surface 50d of the main body 50 of the catalytic combustion portion 5. Accordingly, even when moisture adhering to the contact portion 90 of the first gas contact member 9 flows down in the state of droplets, though the droplets are stored on the bottom surface 53d of the upstream moisture storage portion 53, the droplets can be restrained from entering the main body 50 of the catalytic combustion portion 5. In this term also, the temperature of the main body 50 of the catalytic combustion portion 5 can rise early, the main body 50 of the catalytic combustion portion 5 can start warming-up operation early, the temperature of the shift portion 3 can rise early, and the shift portion 3 can start operation early.

There is a danger that droplets condensed in the second return passage 70 flow down and enter a downstream side of the catalytic combustion portion 5. Regarding this point, in this example, as illustrated in FIG. 3, a downstream moisture storage portion 55 is provided at the warming-up outlet 5p side of the catalytic combustion portion 5, in other words, downstream of the main body 50 of the catalytic combustion portion 5. The downstream moisture storage portion 55 has a space 55r for storing moisture. A level of a bottom surface 55d of the downstream moisture storage portion 55 is set lower than that of the bottom surface 50d of the main body 50 of the catalytic combustion portion 5. Accordingly, even when moisture is stored in the downstream moisture storage portion 55 in the state of liquid, the moisture can be restrained from entering the main body 50 of the catalytic combustion portion 5. In this term also, the temperature of the main body 50 of the catalytic combustion portion 5 can rise early, the main body 50 of the catalytic combustion portion 5 can start warming-up operation early, the temperature of the shift portion 3 can rise early, and the shift portion 3 can start operation early.

In the meantime, the amount of moisture stored on the bottom surface 53d of the upstream moisture storage portion 53 and on the bottom surface 55d of the downstream moisture storage portion 55 in the state of liquid is not so large. When the mode of the fuel cell system transfers to a normal operation from startup operation, the temperature of the upstream moisture storage portion 53 and the downstream moisture storage portion 55 of the catalytic combustion portion 5 rises to substantially high temperature, for example, 100 to 300° C. Accordingly, even when moisture is stored on the bottom surface 53d of the upstream moisture storage portion 53 and on the bottom surface 55d of the downstream moisture storage portion 55 at the time of startup, the moisture vaporizes and disappears at the time of normal operation, which can be further advantageous for restraining the moisture from entering the main body 50 of the catalytic combustion portion 5.

As illustrated in FIGS. 3 and 4, a second gas contact member 95 having a plate shape is provided at the downstream moisture storage portion 55 provided downstream of the main body 50 of the catalytic combustion portion 5. The second gas contact member 95 restrains water flowing down from the second return passage 70 from entering the main body 50 of the catalytic combustion portion 5.

When the fuel cell electric power generation system stops the normal operation, in other words, when the reforming apparatus stops reforming operation, supply of the reformed gas to the warming-up portion 5 through the cooling portion 6 is stopped. At this time, if the first valve 81 is opened, air can be blown from the third passage 73 to the warming-up inlet 5i of the warming-up portion 5 for a predetermined time (blowing means). In this situation, air flows in the main body 50 of the warming-up portion 5 including the catalyst 5c. In the meantime, the reformed gas is not supplied to the warming-up inlet 5i of the warming-up portion 5 from the second bypass passage 80.

As described above, in a condition that supply of the reformed gas to the warming-up portion 5 is stopped, if air is blown to the warming-up inlet 5i of the warming-up portion 5, moisture existing in the warming-up portion 5, moisture existing in the main body 50 of the warming-up portion 5, and moisture existing in a pipe connected to the warming-up portion can be carried away, and can be separated from the warming-up portion 5 and the pipe.

Accordingly, moisture (water vapor, water droplets, or the like) existing in the catalyst 5c for catalytic combustion included in the main body 50 of the warming-up portion 5 can be efficiently blown away and separated from the catalyst 5c. Accordingly, catalytic activity of the catalyst 5c can be enhanced. If air is blown to the warming-up portion 50 while the temperature of the warming-up portion 50 is high, moisture can be easily vaporized and carried away. Further, the blow of air can remove remaining reformed gas and CO components contained in the reformed gas existing in the main body 50 of the warming-up portion 5, which is further advantageous for enhancing catalytic activity of the catalyst 5c.

Generally, it is not preferable if the reformed gas not having been combusted and CO gas exist in the catalyst 5c for catalytic combustion in the main body 50 of the warming-up portion 5. In particular, if CO adheres to the catalyst 5c for catalytic combustion, ignitionability would be lowered at the time of next operation. It can be expected that, in a condition that a temperature of the main body 50 of the warming-up portion 5 is high, such remaining reformed gas and CO can be combusted if air is blown to the warming-up inlet 5i of the warming-up portion 5 from the third passage 73 for a predetermined time at the time of ending operation as described above. Accordingly, degradation of ignitionability at the time of starting the fuel cell electric power generation system caused by adhesion of CO gas can be inhibited.

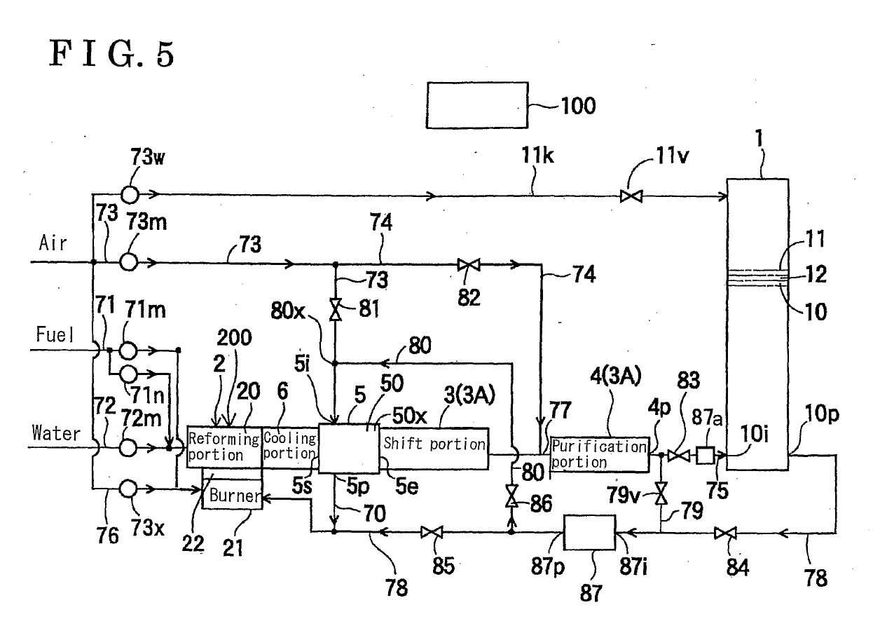

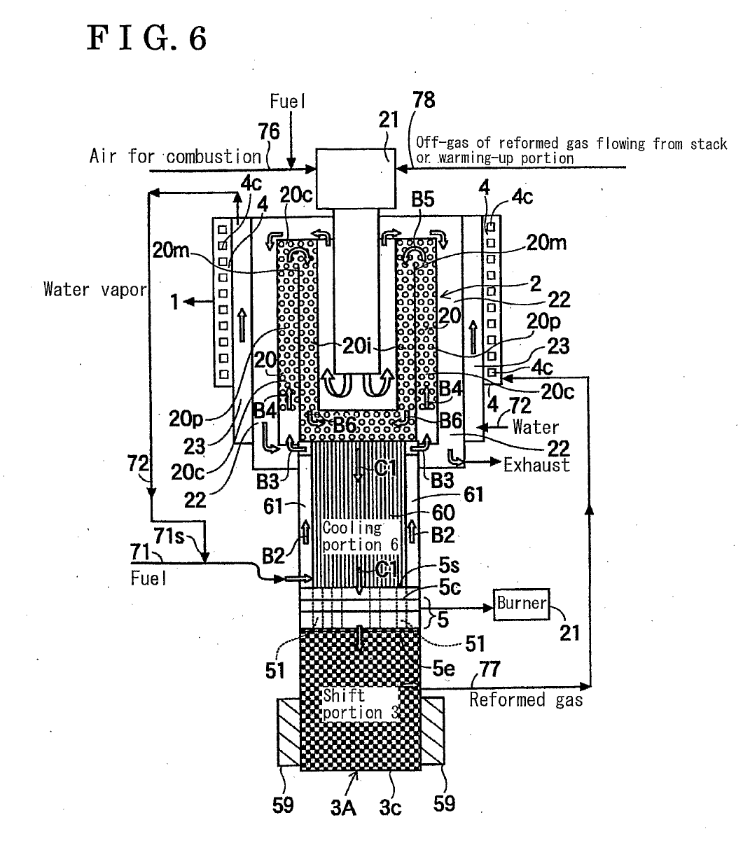

A second example will be explained with reference to drawing figures. FIG. 5 represents a schematic diagram illustrating a system of a reforming apparatus. FIG. 6 represents a schematic diagram illustrating the reforming apparatus. This example has basically similar configuration, action and effect to that of the first example. Accordingly, difference from the first example will be mainly explained. In this example, as illustrated in FIG. 5, the purification portion 4 is provided outside the vaporization portion 23. In other words, the vaporization portion 23 for generating vapor is provided between the purification portion 4 and the combustion zone 22. Because the vaporization portion 23 consumes a lot of heat for vaporization, the purification portion 4 and the catalyst 4c can be inhibited from being overheated.

In the first example, at the time of startup, the reformed gas is not supplied to the fuel cell stack 1. Similarly, in the second example also, the reformed gas bypasses the fuel cell stack 1. Then, the reformed gas flows back to the burner 21, and is combusted in the burner 21 in an initial stage. In other words, as illustrated in FIG. 5, the reformed gas having passed the purification portion 4 is supplied to the inlet 87i of the condenser 87 through the bypass valve 79v and the first bypass passage 79. The reformed gas is cooled in the condenser 87. At this time, moisture contained in the reformed gas is condensed and the amount of moisture contained in the reformed gas is reduced. After that, the reformed gas flows to the burner 21 through the opened fifth valve 85 and the first return passage 78.

In this example, as illustrated in FIG. 6, an electric heater 59 (means for promoting activity of the carbon monoxide reduction portion) is attached to the shift portion 3. The electric heater 59 functions as a heating portion for heating the shift portion 3. Precisely, the electric heater 59 has a cylindrical shape having a ring cross-section, and is provided at the peripheral side of the shift portion 3.

According to this example, at the time of startup, the electric heater 59 generates heat. Accordingly, the shift portion 3 is heated early, and duration of time required for the temperature of the shifting catalyst 3c of the shift portion 3 to become within the active temperature range can be shortened. Then, when a mode of the fuel cell system transfers to a normal operation from startup, the electric heater 59 can be switched off.

Thus, because the temperature of the shifting catalyst 3c of the shift portion 3 reaches the active temperature range earlier, the reformed gas can be purified by the shift portion 3 at the time of startup, and a concentration of CO contained in the reformed gas can be lowered earlier. Then, after the purification of the reformed gas progresses and the concentration of CO contained in the reformed gas is lowered (to, for example, lower than from 0.01% to 0.1% in terms of mole %), the sixth valve 86 is opened. At this time, the fifth valve 85 is closed.

Then, the reformed gas, of which moisture is reduced in the condenser 87, is introduced to the warming-up inlet 5i of the catalytic combustion portion 5 through the outlet 87p of the condenser 87, the sixth valve 86, and the second bypass passage 80. At this time, the first valve 81 is opened for introducing air for catalytic combustion to the warming-up inlet 5i of the catalytic combustion portion 5 through the first valve 81. The reformed gas introduced to the warming-up inlet 5i of the catalytic combustion portion 5 (containing hydrogen as a main component, which excels in a combustibility at a low temperature) passes through an inner portion of the main body 50 of the catalytic combustion portion 5 in a direction indicated by an arrow E1 (illustrated in FIG. 4) together with air introduced to the warming-up inlet 5i of the catalytic combustion portion 5, and is catalytically combusted in the main body 50 of the catalytic combustion portion 5 with use of the catalyst 5c. Accordingly, at the time of startup, the temperature of the shift portion 3 can rise by effect of the catalytic combustion portion 5. When the temperature of the shift portion 3 rises, or, after an ignition in the catalytic combustion portion 5 is confirmed, the electric heater 59 can be switched off.

According to this example, heat generated in the catalytic combustion portion 5, of which the temperature has risen, can be efficiently transmitted to the shift portion 3 and the purification portion 4 provided downstream of the catalytic combustion portion 5. As a result, at the time of startup, a rate of temperature rise at the shift portion 3 and the purification portion 4 can be higher, the temperature of the shift portion 3 and the purification portion 4 can reach early within the active temperature range of the catalysts 3c and 4c, and purification efficiency for reformed gas can be enhanced early.

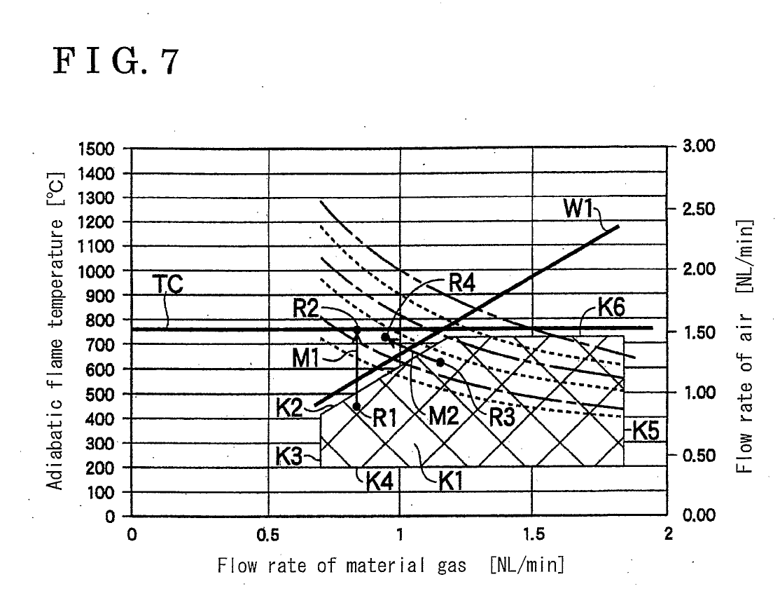

Next, details of startup operation according to the second example will be explained. FIG. 7 represents a graph indicating a relation between a combustible limit and an adiabatic flame temperature. The adiabatic flame temperature is a theoretical temperature of flame when the reformed gas as the fuel gas is completely combusted adiabatically. A horizontal axis of FIG. 7 represents a flow rate of a material gas (natural gas 13A) as the reformed gas supplied to the reforming portion 2. A first vertical axis of FIG. 7 represents the adiabatic flame temperature of the reformed gas. A second vertical axis of FIG. 7 represents a flow rate of supplied air. Here, a combustible range represents a range within which a condition that flame of oxidative combustion can spread and be sustained is satisfied. The combustible limit represents a limit of the combustible range. A characteristic line W1 in FIG. 7 represents a flow rate of air supplied in the state of combustible limit. An area upper than the characteristic line W1 in FIG. 7 corresponds to a combustible range within which flame can continue spreading. An area lower than the characteristic line W1 corresponds to a condition out of the combustible range. Each of characteristic lines S1-S6 represents a flow rate of air corresponding to each temperature of air at which the air is introduced to the catalytic combustion portion 5 (saturated vapor). TC represents a resistible temperature of the catalyst 5c in the main body 50 of the catalytic combustion portion 5. In this example, the resistible temperature is set to 750° C. The resistible temperature of a catalyst represents an upper limit of temperature at which the catalyst can normally utilized without degradation to some extent.

In this example, a catalytic combustion control portion 100 is provided for controlling catalytic combustion in the catalytic combustion portion 5. The catalytic combustion control portion 100 performs ignition control in the main body 50 of the catalytic combustion portion 5. In the ignition control, when combustion starts in the catalytic combustion portion 5, air is introduced to the warming-up inlet 5i of the catalytic combustion portion 5 from the opened first valve 81 and the reformed gas is introduced to the warming-up inlet 5i of the catalytic combustion portion 5 from the opened sixth valve 86 so that the fuel gas and air are combusted in a condition out of the combustible range, the combustible range in which a fuel gas and air are combusted with generation of flame. As a result, the main body 50 of the catalytic combustion portion 5 is ignited in condition within the area K1. Here, in the area K1, the reformed gas is combusted without generating flame, in other words, in condition within no flame area. The area K1 is positioned lower than a position of characteristic line W1, indicating the flow rate of air at the combustible limit, and lower than a position of the line TC, indicating the resistible temperature of the catalyst 5c. The area 1 is defined by lines K2-K6. Because combustibility of catalytic combustion is high, even in the area 1 out of combustible range, the main body 50 of the catalytic combustion portion 5 can be ignited.

According to this example, after it is judged that the main body 50 of the catalytic combustion portion 5 has been ignited, the catalytic combustion control portion 100 increases the flow rate of air supplied to the warming-up inlet 5i of the catalytic combustion portion 5 from that at the time of the ignition control. This will be referred as an increasing-operation. At this time, the amount of air can be within the combustible range over the characteristic line W1 indicating a limit of the combustible range. However, it is not limited. The amount of air can be out of the combustible range. Here, the judgment of the ignition of the main body 50 of the catalytic combustion portion 5 can be made when the temperature of the main body 50 of the catalytic combustion portion 5 rises from a temperature T1 of that at the time before the ignition operation by a temperature °Ta (for example, 80° C.) or higher. The temperature °Ta can be set appropriately according to a basic component of the reformed gas, a kind of catalysts 5c, or the like.

At the time of the increasing-operation described above, the degree of opening of the sixth valve 86 is constant and the flow rate of the fuel gas supplied to the warming-up inlet 5i of the catalytic combustion portion 5 does not change basically. For example, the ignition operation is performed in a state indicated by a position R1 in FIG. 7, the amount of air is increased in a direction of an arrow M1 illustrated in FIG. 7, and the amount of air is made into a state indicated by a position R2 in FIG. 7. Or, the ignition operation is performed in a state indicated by a position R3 in FIG. 7, the amount of air is increased in a direction of an arrow M2 illustrated in FIG. 7, and the amount of air is made into a state indicated by a position R4 in FIG. 7.

In the increasing-operation described above, the temperature of the main body 50 of the catalytic combustion portion 5 is set so as not to exceed the resistible temperature TC of the catalyst 5c supported in the main body 50 of the catalytic combustion portion 5. Or, if the temperature of the main body 50 of the catalytic combustion portion 5 temporarily exceeds the resistible temperature TC of the catalyst 5c, the temperature of the main body 50 of the catalytic combustion portion 5 is set so as not to excessively frequently exceed the resistible temperature TC of the catalyst 5c. As a result, thermal deterioration of the catalyst 5c supported in the main body 50 of the catalytic combustion portion 5 can be inhibited, which is advantageous for increasing longevity of the catalyst 5c.

As described above, according to this example, even when an air-fuel ratio, which is a ratio between the amount of combustible component and air contained in the reformed gas, varies, or, even when the temperature of the catalyst 5c is low and the fuel gas contains CO gas, or, the fuel gas contains moisture such as water vapor or water droplets, or such other situations, ignition of the main body 50 of the catalytic combustion portion 5 can be preferably performed. Accordingly, at the time of ignition, generation of flame in a pipe downstream of the catalytic combustion portion 5 can be inhibited, and combustion in the main body 50 of the catalytic combustion portion 5 can be simply controlled. Further, after the ignition, the amount of air is increased and combustion in the main body 50 of the catalytic combustion portion 5 can be preferably performed, which is advantageous to reliably obtain the amount of heat generated in the catalytic combustion portion 5.

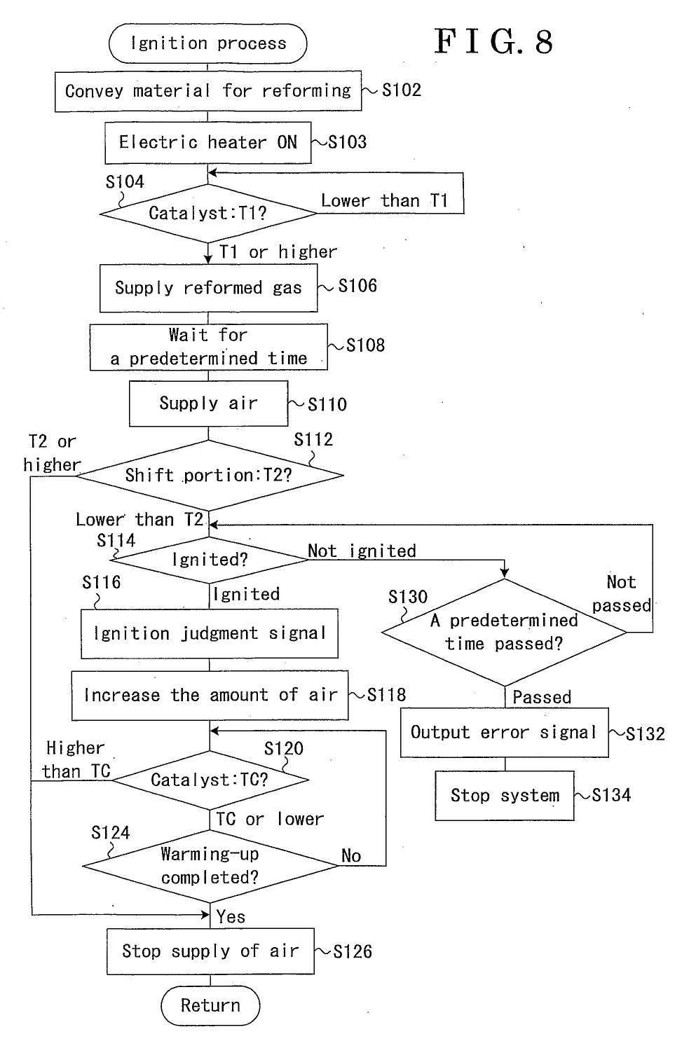

FIG. 8 represents an example of a flow chart illustrating a control performed by the catalytic combustion control portion 100. A control performed by the catalytic combustion control portion 100 is not limited to this flow chart. At first, the fuel and water, which are materials for reforming, are conveyed into the reforming portion 2 (Step S102). By doing so, the reformed gas is generated in the reforming portion 2. Then, the electric heater 59 is switched on for a predetermined period of time to heat the shift portion 3 (Step S103). By doing so, a temperature of at least a part of the shift portion 3 can reach the active temperature range early, purifying ability in the shift portion 3 can be enhanced, and a concentration of CO contained in the reformed gas can be lowered. Thus, because the concentration of CO contained in the reformed gas passing through the reformed gas passage 51 of the catalytic combustion portion 5 is lowered, adhesion of CO at reaction sites of the catalyst 5c can be inhibited. In the meantime, the electric heater 59 is switched off after a lapse of the predetermined period of time.

Next, it is judged whether the temperature of the catalyst 5c of the main body 50 of the catalytic combustion portion 5 is a first set temperature T1 (for example, 90° C.) or higher, or not (Step S104). In the meantime, when the temperature of the catalyst 5c is too low, even when a concentration of CO contained in the reformed gas is lowered, the combustion catalyst is not easily ignited. Therefore, when the temperature of the catalyst 5c of the main body 50 of the catalytic combustion portion 5 does not reach the first set temperature T1, because the temperature is too low, the catalytic combustion control portion 100 waits until the temperature of the main body 50 of the catalytic combustion portion 5 reaches the first set temperature T1 (Step S104). Thus, the step S104 serves as a means for judging an appropriate ignition temperature, which judges whether the temperature of the catalyst 5c of the main body 50 of the catalytic combustion portion 5 is suitable for ignition or not.

When the temperature of the catalyst 5c of the main body 50 of the catalytic combustion portion 5 is the first set temperature T1 or higher, the sixth valve 84 is opened to supply the reformed gas to the warming-up inlet 5i of the catalytic combustion portion 5 through the second bypass passage 80 (Step S106). After the lapse of a predetermined time (Step S108), the first valve 81 is opened to supply air to the warming-up inlet 5i of the catalytic combustion portion 5 (Step S110), thereby to ignite the catalytic combustion portion 5 (ignition operation). As described above, at the time of ignition, though the amount of air is smaller than that in a normal combustible range, at least a part of the shift portion 3 is heated by the electric heater 59 and is activated early as described above. Accordingly, a concentration of CO contained in the reformed gas can be substantially lowered, and the reformed gas can contain hydrogen as a main component. Thus, ignitionability in the catalytic combustion portion 5 can be ensured.

In the meantime, the reason why air is supplied to the warming-up inlet 5i after the reformed gas is supplied to the warming-up inlet for 5i is to inhibit unnecessary ignition. Accordingly, steps S106, S108, and S110 serves as a means for prioritizing fuel gas, which supplies a fuel gas to the catalytic combustion portion 5 in higher priority than that of air.

Then, it is judged whether a temperature at a site where the temperature of the shift portion 3 is measured is a second set temperature T2 (for example, 170° C.) or higher, or not (Step S112). If the temperature at the site where the temperature of the shift portion 3 is the second set temperature or higher, it is judged that the shift portion 3 is sufficiently activated and further warming-up of the shift portion 3 is not necessary. Accordingly, the process returns to a main routine. If the temperature at the site where the temperature of the shift portion 3 is lower than the second set temperature T2, it is judged that the shift portion 3 is not sufficiently activated, the shift portion 3 needs to be warmed up, and the temperature of the catalytic combustion portion 5 needs to rise. Accordingly, the step S112 serves as a means for judging whether warming-up is required, which judges whether the temperature of the catalytic combustion portion 5 needs to rise to warm up the shift portion 3.

Then, it is judged whether the temperature of the catalyst 5c of the main body 50 of the catalytic combustion portion 5 has risen from the first set temperature T1 by the temperature °Ta (for example, 80° C.) (Step S114). When the temperature of the catalyst 5c has risen from the first set temperature T1 by the temperature °Ta, it is judged that the catalyst 5c of the main body 50 of the catalytic combustion portion 5 is ignited, and an ignition judgment signal is transmitted (Step S116). Accordingly, the step S114 serves as a means for judging ignition, which judges whether the main body 50 of the catalytic combustion portion 5 is ignited or not. After that, the increasing-operation is performed, in which a flow rate of air supplied to the warming-up inlet 5i of the catalytic combustion portion 5 by increasing the degree of opening of the first valve 81 or by increasing the amount of air conveyed by the conveying element 73m (Step S118). By doing so, catalytic combustion in the catalytic combustion portion 5 can proceed, the amount of generated heat can be reliably obtained, and performance of the catalytic combustion portion 5 to warm up the shift portion 3 can be ensured.

Next, it is judged whether the temperature in the catalytic combustion portion 5 is the resistible temperature TC of the catalyst 5c of the main body 50 of the catalytic combustion portion 5 or lower, or not, by means of a temperature sensor 50x (temperature detecting means) provided in the catalytic combustion portion 5 (Step S120). When the temperature in the catalytic combustion portion 5 exceeds the resistible temperature TC of the catalyst 5c of the main body 50 of the catalytic combustion portion 5, supply of air to the warming-up inlet 5i of the catalytic combustion portion 5 is stopped (Step S126) for protecting the catalyst 5c from overheat. Thus, warming-up operation by means of the catalytic combustion portion 5 is stopped. Accordingly, steps S120 and S126 serve as a catalyst-protecting means for thermally protecting the catalyst 5c of the catalytic combustion portion 5. Then, it is judged whether warming-up of the shift portion 3 is completed or not (Step S124). In other words, it is judged whether the temperature at the site where the temperature of the shift portion 3 is measured is the second set temperature T2 or higher, or not. When the temperature at the site where the temperature of the shift portion 3 is measured is the second set temperature T2 or higher (YES), it is judged that the-warming up of the shift portion 3 is completed. Then, supply of air to the warming-up inlet 5i is stopped (Step S126), and the warming-up operation by the catalytic combustion portion 5 is stopped. Then, the process returns to a main routine. When the temperature at the site where the temperature of the shift portion 3 is measured is lower than the second set temperature T2 (NO), because the warming-up of the shift portion 3 has not been completed yet, process returns to the step S120. Then, air is continuously supplied to the warming-up inlet 5i. Accordingly, the step S124 serves as a means for judging completion of warming-up, which judges a time for terminating the warming-up operation by the catalytic combustion portion 5.

In the step S114, when the temperature of the catalyst 5c of the main body 50 of the catalytic combustion portion 5 has not risen from the first set temperature T1 by the temperature °Ta, it is assumed that the main body 50 of the catalytic combustion portion 5 is not ignited. Then, it is judged whether a predetermined period of time from the time of the ignition operation described above is passed or not (Step S130). If the predetermined period of time has not passed, the process returns to the step S114, and the judging process for judging whether the main body 50 of the catalytic combustion portion 5 is ignited or not is continuously performed. If the main body 50 of the catalytic combustion portion 5 is not ignited after the predetermined period of time has passed, it is judged that the fuel cell electric power generation system is in an abnormal state (Step S132). Then, the system is stopped (Step S134). Thus, the steps S114 and S130 serve as a means for judging ignition failure, which judges ignition failure in the catalytic combustion portion 5.

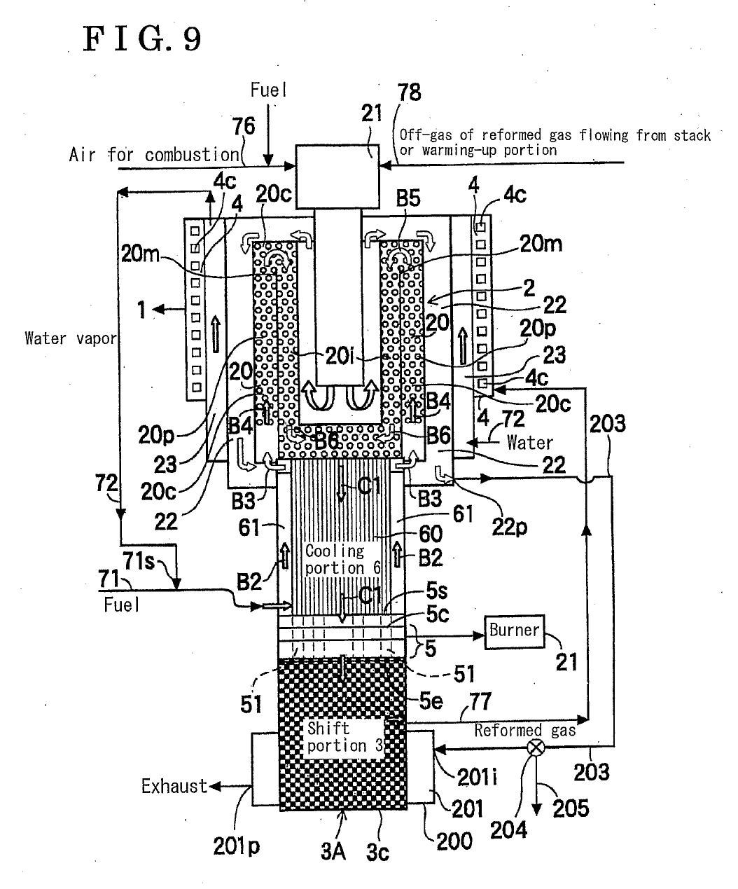

A third example will be explained with reference to drawing figures. FIG. 9 represents a third example. This example has basically similar configuration, action and effect to that of the second example. Accordingly, FIGS. 3, 4, 5 and 7 can be commonly utilized. In following, difference from the second example will be mainly explained. In this example, as illustrated in FIG. 9, an exhausted combustion gas passage 200 serving as a means for promoting activation, which promotes temperature rise of the shift portion 3, is provided at the shift portion 3 serving as a part of the carbon monoxide reduction portion. The exhausted combustion gas passage 200 includes a ring-shaped heating passage 201 provided at a peripheral portion of the shift portion 3. The heating passage 201 has an inlet 201i and an outlet 201p. The exhausted combustion gas passage 200 further includes a heating passage 203 connecting the inlet 201i of the heating passage 201 with the outlet 22p of the combustion zone 22 of the reforming portion 2, a switching valve 204 serving as a flow passage-switching means, and a bypass exhaust passage 205 for bypassing the heating passage 201.

When the reforming portion 2 is in operation, exhausted combustion gas exhausted from the outlet 22p of the combustion zone 22 of the reforming portion 2 flows through the heating passage 203 and the heating passage 201 thereby to heat the shift portion 3. Accordingly, at the time of startup, a temperature of the shift catalyst 3c in the shift portion 3 can reach within active temperature range in short time. As a result, at the time of startup, a concentration of CO contained in the reformed gas can be lowered. As described above, because the reformed gas introduced to the warming-up inlet 5i of the catalytic combustion portion 5 is purified, adhesion of CO to the catalyst 5c of the catalytic combustion portion 5 can be inhibited. Accordingly, at the time of startup, ignitionability and combustibility in the catalytic combustion portion 5 can be improved. After the ignition, as described in the second example, a flow rate of air supplied to the catalytic combustion portion 5 can be increased.

At the time of normal operation or the like, when the temperature in the shift portion 3 becomes too high, a flow rate of the exhausted combustion gas flowing toward the heating passage 201 can be lowered or become to 0 by means of the switching valve 204, and the exhausted combustion gas can be exhausted from the bypass exhaust passage 205. By doing so, overheat of the shift portion 3 can be inhibited, which can enhance protection of the shift catalyst 3c. The switching valve 204 and the bypass exhaust passage 205 can serve as a catalyst protecting means for protecting the shift catalyst 3c of the shift portion 3.

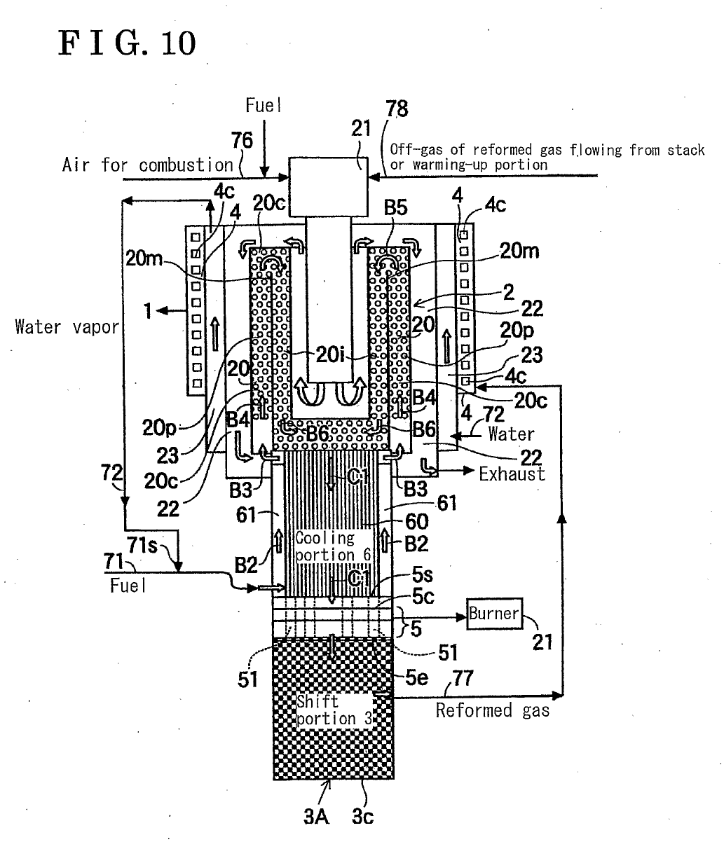

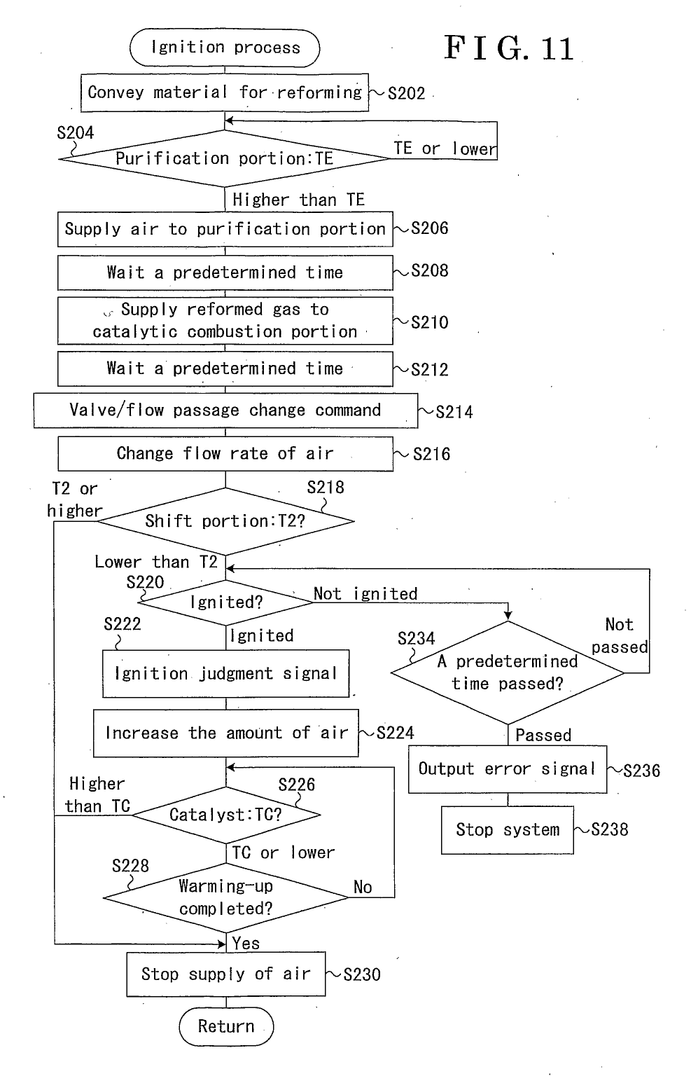

A fourth example will be explained with reference to drawing figures. FIGS. 10 and 11 represent the fourth example. This example has basically same configuration, action and effect as in the second example. Accordingly, FIGS. 3, 4, 5, and 7 can be commonly utilized. In following, difference from the second example will be mainly explained. In this example also, as illustrated in FIG. 10, the purification portion 4 is provided at a position to which heat can be transmitted from the reforming portion 2. Precisely, the purification portion 4 is integrally and cylindrically provided at a peripheral portion of the reforming portion 2. A cross section of the purification portion 4 has a ring shape. At the time of startup, because the temperature of the reforming portion 2 becomes high early, the temperature of the purification portion 4 can reach within an active temperature range thereof in short time. Accordingly, adhesion of CO contained in the reformed gas to the catalyst 5c of the catalytic combustion portion 5 can be inhibited, which is advantageous for enhancing ignitionability and combustibility in the catalytic combustion portion 5.

Further, at the time of startup, the catalytic combustion control portion 100 opens the second valve 82 for introducing air (oxygen) into the purification portion 4 through the second valve 82 and the fourth passage 74. By doing so, according to reaction formula 3, CO gas contained in the reformed gas reacts with oxygen, and as a result, carbon dioxide is produced. Thus, a concentration of CO gas contained in the reformed gas can be reduced. This reaction is an exothermal reaction. Accordingly, this reaction is advantageous for raising the temperature of the purification portion 4 and for activating the purification portion 4, and further advantageous for enhancing ignitionability and combustibility in the catalytic combustion portion 5.

FIG. 11 represents a flow chart illustrating an example of a control performed by the catalytic combustion control portion 100. A control performed by the catalytic combustion control portion 100 is not limited to this flow chart. At first, the fuel and water, serving as materials for reforming, are conveyed into the reforming portion 2 (Step S202). By doing so, the reformed gas is produced in the reforming portion 2. Next, it is judged whether a temperature in the purification portion 4 rises and exceeds a set temperature TE (for example, 80° C.) (Step S204). The set temperature TE corresponds a temperature rather lower than the active temperature range of the purification portion 4. When the temperature of the purification portion 4 does not exceed the set temperature TE, the catalytic combustion control portion 100 waits until the temperature of the purification portion 4 exceeds the set temperature (Step 204). When the temperature of the purification portion 4 exceeds the set temperature TE, the second valve 82 (the second opening/closing means) is opened to supply air (oxygen) for purification to the purification portion 4 through the fourth passage 74 (Step S206). CO gas contained in the reformed gas reacts with the oxygen, and carbon dioxide is generated. Thus, purifying reaction proceeds in the purification portion 4, and a concentration of CO contained in the reformed gas can be lowered. Further, the catalytic combustion control portion 100 waits for a predetermined period of time (Step S208). In this period of time, a temperature of the main body 50 of the catalytic combustion portion 5 rises gradually, and a temperature of the purification portion 4 also rises gradually. The step S206 can serve as a means for promoting activation, which, at the time of startup, supplies oxygen to the purification portion 4 serving as the carbon monoxide reduction portion. The steps S206, S208, S210 can serve as a means for promoting activation, which, at the time of startup, supplies the fuel gas, of which concentration of CO has been lowered, to the catalytic combustion portion 5 after the purification portion 4 is activated by supply of oxygen to the purification portion 4 serving as the carbon monoxide reduction portion.

Next, the sixth valve 86 is opened, and the reformed gas, of which concentration of CO has been lowered, is supplied to the warming-up inlet 5i of the catalytic combustion portion 5 through the condenser 87, the sixth valve 86, and the second bypass passage 80 (Step S210). Then, the catalytic combustion control portion 100 waits a predetermined period of time (Step S212). In this period of time, the reformed gas is introduced to the catalytic combustion portion 5. After that, the catalytic control portion 100 transmits a valve/flow passage change command (Step S214). As a result, the first valve 81 is opened, and air is supplied to the warming-up inlet 5i of the catalytic combustion portion 5 (Step S216). Thus, the catalytic combustion control portion 100 performs the ignition operation for igniting the catalytic combustion portion 5. At this time, it is possible to reduce the degree of opening of the second valve 82, or to close the second valve 82. As described above, the reason why air is supplied to the warming-up inlet 5i after the reformed gas is supplied to the warming-up inlet 5i is to inhibit unnecessary ignition. The steps S210, S212, S214, and S216 serve as a means for prioritizing fuel gas, which supplies the fuel gas to the catalytic combustion portion 5 in higher priority than that of air.

Then, it is judged whether a temperature at a site where a temperature of the shift portion 3 is measured is the second set temperature T2 (for example, 170° C.) or higher, or not (Step S218). When the temperature at the site where the temperature of the shift portion 3 is measured is the second set temperature T2 or higher, it is judged that the shift portion 3 is sufficiently activated and further warming-up of the shift portion 3 is unnecessary. Then, supply of air is stopped (Step S230), and the process returns to a main routine. On the other hand, when the temperature at the site where the temperature of the shift portion 3 is lower than the second set temperature T2, it is judged that the shift portion 3 is not sufficiently activated, the shift portion 3 needs to be warmed up, and the temperature of the catalytic combustion portion 5 needs to further rise. Thus, the step S218 serves as a means for judging whether warming-up is required, which judges whether the temperature of the catalytic combustion portion 5 needs to rise to warm up the shift portion 3.

Then, it is judged whether the catalyst 5c of the main body 50 of the catalytic combustion portion 5 is ignited or not (Step S220). In other words, it is judged whether the temperature of the catalytic combustion portion 5 rises from the first set temperature T1, which is an initial temperature, by the temperature °Ta (for example, 80° C.) or not. When the temperature of the catalytic combustion portion 5 rises from the first set temperature T1 by the temperature °Ta, it is judged that the catalyst 5c of the main body 50 of the catalytic combustion portion 5 is ignited. Then, an ignition judgment signal is transmitted (Step S222). Thus, the step S220 serves as a means for judging ignition, which judges whether the main body 50 of the catalytic combustion portion 5 is ignited or not.

After that, the degree of opening of the first valve 81 is increased or the amount of air conveyed by the conveying element 73m is increased for increasing the flow rate of air supplied to the warming-up inlet 5i of the catalytic combustion portion 5 (operation for increasing oxygen) (Step S224). By doing so, catalytic combustibility of the catalytic combustion portion 5 can be further enhanced, the amount of heat generated in the catalytic combustion portion 5 can be obtained with reliability, and performance of the catalytic combustion portion for warming-up can be ensured.

Next, it is judged whether the temperature in the catalytic combustion portion 5 is the resistible temperature TC of the catalyst 5c of the main body 50 of the catalytic combustion portion 5 or lower, or not, by means of a temperature sensor 50x (temperature detecting means) provided in the catalytic combustion portion 5 (Step S226). When the temperature in the catalytic combustion portion 5 exceeds the resistible temperature TC of the catalyst 5c of the main body 50 of the catalytic combustion portion 5, for protecting the catalyst 5c from overheat, supply of air to the warming-up inlet 5i of the catalytic combustion portion 5 is stopped (Step S230), and warming-up operation by means of the catalytic combustion portion 5 is stopped. Accordingly, steps S226 and S230 serve as a catalyst-protecting means for thermally protecting the catalyst 5c of the catalytic combustion portion 5.

Then, it is judged whether warming-up of the shift portion 3 is completed or not (Step S228). In other words, it is judged whether the temperature at the site where the temperature of the shift portion 3 is measured is the second set temperature T2 or higher, or not. When the temperature at the site where the temperature of the shift portion 3 is measured is the second set temperature T2 or higher (YES), it is judged that the warming-up of the shift portion 3 is completed. Then, supply of air to the warming-up inlet 5i is stopped (Step S230), and the warming-up operation by the catalytic combustion portion 5 is stopped. Then, the process returns to a main routine. When the temperature at the site where the temperature of the shift portion 3 is measured is lower than the second set temperature T2, because the warming-up of the shift portion 3 has not been completed yet (NO), the process returns to the step S226. Then, air is continuously supplied to the warming-up inlet 5i. Thus, the step S228 serves as a means for judging completion of warming-up, which judges a time for ending the warming-up operation by the catalytic combustion portion 5.

In the step S220, when the temperature of the catalyst 5c of the main body 50 of the catalytic combustion portion 5 does not rise from the first set temperature T1 by the temperature °Ta, it is assumed that the main body 50 of the catalytic combustion portion 5 is not ignited. At this time, it is judged whether a predetermined period of time from the time of the ignition operation described above is passed or not (Step S234). If the predetermined period of time has not passed, the process returns to the step S220, and the judging process for judging whether the main body 50 of the catalytic combustion portion 5 is ignited or not is continuously performed. If the main body 50 of the catalytic combustion portion 5 is not ignited after the predetermined period of time has passed, it is judged that the fuel cell electric power generation system is in an abnormal state (Step S236) Then, the system is stopped (Step S238). Thus, the steps S220 and S234 serve as a means for judging ignition failure, which judges ignition failure in the catalytic combustion portion 5.

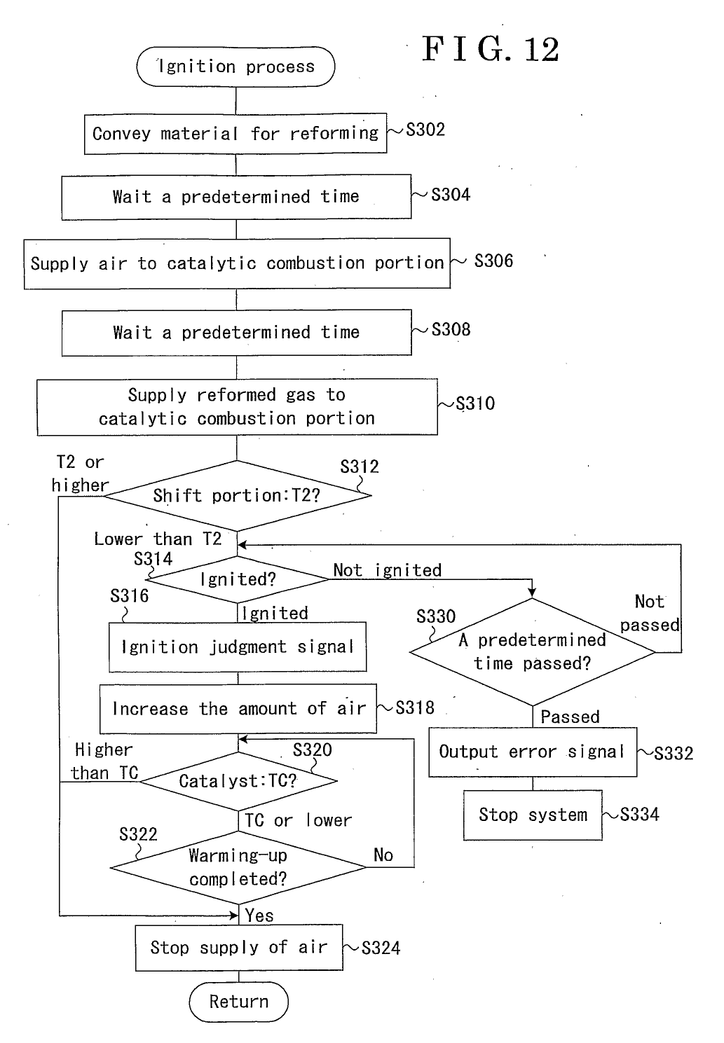

A fifth example will be explained with reference to drawing figures. FIG. 12 represents a flow chart according to the fifth example. This example has basically same configuration, action and effect as in the second example. Accordingly, FIGS. 3, 4, 5, 6, and 7 can be commonly utilized. In following, difference from the second example will be mainly explained. In this example, the means for promoting activation includes an introducing means for introducing the fuel gas containing hydrogen and carbon monoxide to the catalytic combustion portion 5 and an oxygen supplying means for supplying air (oxygen) to the catalytic combustion portion 5 before the fuel gas containing hydrogen and carbon monoxide is introduced to the catalytic combustion portion 5 by the introducing means.

FIG. 12 represents an example of a flow chart illustrating a control performed by the catalytic combustion control portion 100. A control performed by the catalytic combustion control portion 100 is not limited to this flow chart. At first, the fuel and water, serving as materials for reforming, are conveyed into the reforming portion 2 (Step S302). By doing so, the reformed gas is produced in the reforming portion 2. Then, the catalytic combustion control portion 100 waits until a predetermined period of time lapses (Step S304). After the predetermined period of time lapses, the temperature of the purification portion 4 rises. Next, in a condition where the sixth valve 86 is closed, the first valve 81 is opened for supplying air to the warming-up inlet 5i of the catalytic combustion portion 5. Further, the catalytic combustion control portion 100 further waits for a predetermined period of time (Step S308). By doing so, air flows into the catalytic combustion portion 5. Next, the sixth valve 86 is opened for supplying the reformed gas to the warming-up inlet 5i of the catalytic combustion portion 5 through the sixth valve 86 and the second bypass passage 80 (Step S310). By doing so, the catalytic combustion portion 5 is ignited (ignition operation). In this case, the second valve 82 can be opened or closed.

In the state where air is supplied to the catalytic combustion portion 5 as described above, when the reformed gas containing hydrogen and carbon monoxide is supplied to the catalytic combustion portion 5, even when the reformed gas contains carbon monoxide, ignitionability of the catalytic combustion portion 5 is rather easily obtained. Here, carbon monoxide tends to be absorbed by the catalyst 5c of the catalytic combustion portion 5, which causes degradation of catalyst activity. However, even when CO molecules exist, if combustible hydrogen exists, the catalyst 5c of the catalytic combustion portion 5 can be easily ignited. It is assumed that hydrogen, which can easily be combusted, contributes easiness of ignition. Further, it is assumed that easiness of ignition is caused by that hydrogen molecules have high diffusivity and moving speed higher than that of carbon monoxide molecules because hydrogen molecules have light weight and low viscosity.

Here, when the closed sixth valve 86 is opened, hydrogen molecules and CO molecules move to the catalytic combustion portion 5 through the sixth valve 86 and the warming-up inlet 5i of the catalytic combustion portion 5. In this case, even when a position of the sixth valve 86 is close to the warming-up inlet 5i, because hydrogen has easiness of ignition and ignitionability at low temperature, ignitionability of the catalytic combustion portion 5 can be ensured. Further, the longer a distance from the sixth valve 86 (fuel gas supply valve) to the warming-up inlet 5i is, the longer a time difference between when hydrogen molecules having easiness of ignition reaches the warming-up inlet 5i and when CO molecules having ignition inhibiting property reaches the warming-up inlet 5i can be. Accordingly, an area near the catalytic combustion portion 5 can temporary be in a state of hydrogen-rich and low CO concentration, which can be assumed to improve ignitionalbility and combustibility in the catalytic combustion portion 5. Accordingly, a distance from the sixth valve 86 to the warming-up inlet 5i can be set to some extent. The longer the distance from the sixth valve 86 to the warming-up inlet 5i is, the larger in size an entire system will be. Accordingly, a distance from the sixth valve 86 to the warming-up inlet 5i can be set to, for example, approximately 3 to 100 centimeter. However, because a length from the sixth valve 86 to the warming-up inlet for 5i depends on a size of a fuel cell electric power generation system, the length is not particularly limited. Thus, the steps S306, S308, and S310, serve as a promoting means for promoting ignitionability of the catalytic combustion portion 5 by utilizing earlier reach of hydrogen to the catalytic combustion portion 5 than CO. Here, because hydrogen has high combustibility at low temperature, once the catalytic combustion portion 5 can be ignited, even when CO concentration of the reformed gas becomes high (for example, 10 to 15%), combustibility of the catalytic combustion portion 5 can be maintained.

According to this example, the step S310 can serve as an introducing means for introducing the fuel gas containing hydrogen and carbon monoxide to the catalytic combustion portion 5. The step S306 can serve as an oxygen supply means for supplying oxygen (air) to the catalytic combustion portion 5 before the fuel gas containing hydrogen and carbon monoxide is introduced to the catalytic combustion portion 5 by the introducing means.

Then, it is judged that whether a temperature at a site where a temperature of the shift portion 3 is measured is the second set temperature T2 (for example, 170° C.) or higher, or not (Step S312). When the temperature at the site where the temperature of the shift portion 3 is measured is the second set temperature T2 or higher, it is judged that the shift portion 3 is sufficiently activated, and that warming-up of the shift portion 3 is unnecessary. Then, supply of air is stopped (Step S324), and the process returns to a main routine. When the temperature at the site where the temperature of the shift portion 3 is lower than the second set temperature T2, it is judged that the shift portion 3 is not sufficiently activated, the shift portion 3 needs to be warmed up, and the temperature of the catalytic combustion portion 5 needs to further rise. Thus, the step S312 serves as a means for judging whether warming-up is required, which judges whether the temperature of the catalytic combustion portion 5 needs to rise to warm up the shift portion 3.

Then, it is judged whether the temperature of the main body 50 of the catalytic combustion portion 5 rises from the first set temperature T1 by the temperature °Ta (for example, 80° C.) or not, in other words, whether the catalytic combustion portion 5 is ignited or not (Step S314). When the temperature of the catalytic combustion portion 5 rises from the first set temperature T1 by the temperature °Ta, it is judged that the catalyst 5c of the main body 50 of the catalytic combustion portion 5 is ignited. Then, an ignition judgment signal is transmitted (Step S316). Thus, the step S314 serves as a means for judging ignition, which judges whether the main body 50 of the catalytic combustion portion 5 is ignited or not. After that, the degree of opening of the first valve 81 is increased or the amount of air conveyed by the conveying element 73m is increased for increasing the flow rate of air supplied to the warming-up inlet 5i of the catalytic combustion portion 5 (operation for increasing oxygen) (Step S318). By doing so, catalytic combustibility of the catalytic combustion portion 5 can be further enhanced, the amount of generated heat can be obtained with reliability, and performance of the catalytic combustion portion 5 for warming-up of the shift portion 3 can be ensured.

Next, it is judged whether the temperature in the catalytic combustion portion 5 is the resistible temperature TC of the catalyst 5c of the main body 50 of the catalytic combustion portion 5 or lower, or not, by means of a temperature sensor 50x (temperature detecting means) provided in the catalytic combustion portion 5 (Step S320). When the temperature in the catalytic combustion portion 5 exceeds the resistible temperature TC of the catalyst 5c of the main body 50 of the catalytic combustion portion 5, for protecting the catalyst 5c from overheat, supply of air to the warming-up inlet 5i of the catalytic combustion portion 5 is stopped (Step S324), and warming-up operation by means of the catalytic combustion portion 5 is stopped. Thus, the steps S320 and S324 serve as a catalyst-protecting means for thermally protecting the catalyst 5c of the catalytic combustion portion 5.

Then, it is judged whether warming-up of the shift portion 3 is completed or not (Step S322). In other words, it is judged whether the temperature at the site where the temperature of the shift portion 3 is measured is the second set temperature T2 or higher, or not. When it is judged that the warming-up of the shift portion 3 is completed (YES), the first valve 81 is closed (Step S324) for stopping supply of air to the warming-up inlet 5i, the warming-up operation by the catalytic combustion portion 5 is stopped, and the process returns to a main routine. When the temperature at the site where the temperature of the shift portion 3 is measured is lower than the second set temperature T2 (NO), because the warming-up of the shift portion 3 has not been completed yet, the process returns to the step S320. Then, air is continuously supplied to the warming-up inlet 5i. Thus, the step S322 serves as a means for judging completion of warming-up, which judges a time for ending the warming-up operation by the catalytic combustion portion 5.

In the step S314, when the temperature of the catalyst 5c of the main body 50 of the catalytic combustion portion 5 does not rise from the first set temperature T1 by the temperature °Ta, it is assumed that the main body 50 of the catalytic combustion portion 5 is not ignited. At this time, it is judged whether a predetermined period of time from the time of the ignition operation described above has passed or not (Step S330). If the predetermined period of time has not passed, the process returns to the step S314, and the judging process for judging whether the main body 50 of the catalytic combustion portion 5 is ignited or not is continuously performed. If the main body 50 of the catalytic combustion portion 5 is not ignited after the predetermined period of time has passed, it is judged that the fuel cell electric power generation system is in an abnormal state (Step S332). Then, the system is stopped (Step S334). Thus, the steps S314 and S330 serve as a means for judging ignition failure, which judges ignition failure in the catalytic combustion portion 5.

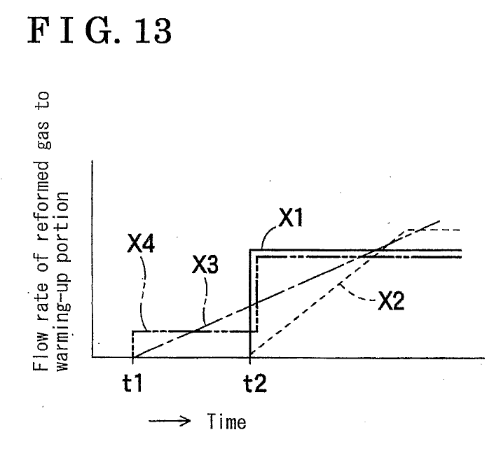

A sixth example will be explained with reference to drawing figures. FIG. 13 represents the sixth example. This example has basically similar configuration, action, and effect to that of the first example. Accordingly, FIGS. 1 to 4 can be applied correspondingly. In following, difference from the first example will be mainly explained. In this example, at the time of startup in a condition that the temperature of the main body 20 of the reforming portion 2 and that of the main body 50 of the warming-up portion 5 are lower than those thereof at the time in normal operation, the means for promoting temperature rise of the main body of the warming-up portion limits introduce of the reformed gas to the main body 50 of the warming-up portion 5. After that, as the temperature of the main body 50 of the warming-up portion 5 rises, the means for promoting temperature rise of the main body 50 of the warming-up portion 5 increases a flow rate of the reformed gas introduced to the main body 50 of the warming-up portion 5.

Precisely, at the time of startup of the gas-reforming apparatus (fuel cell electric power generation system), because the temperature of the main body 50 of the warming-up portion 5 is low, the main body 50 of the warming-up portion 5 cannot be easily ignited even when the catalyst 5c is included in the main body 50 of the warming-up portion 5. In addition, though concentration of CO contained in the reformed gas is low at the time of normal operation, because CO concentration in the reformed gas is high at the time immediately after startup, there is a danger that CO contained as impurity in the reformed gas adheres to reaction sites of the catalyst 5c of the main body 50 of the warming-up portion 5. Accordingly, there is a danger that ignitionability and combustibility of the catalyst 5c of the main body 50 of the warming-up portion 5 is further degraded.

For solving such adverse effect described above, at the time t1 of starting startup operation, the sixth valve 86 is closed and the second bypass passage 80 is closed so that the reformed gas of which concentration of CO is high is not introduced to the warming-up inlet 5i of the warming-up portion 5. In this case, because the fifth valve 85 is opened, the reformed gas flowing from the first bypass passage through the valve 79v flows to the burner 21 through the first return passage 78, the condenser 87, and the fifth valve 85, and is combusted in the burner 21. Then, from the time t2 when the temperature of the main body 50 of the warming-up portion 5 rises and the temperature becomes a temperature TA at which the catalyst 5c of the main body 50 of the warming-up portion 5 can be easily ignited, the sixth valve 86 is opened and the second bypass passage 80 is opened. At the time t2, the temperature of the main body 20 of the reforming portion 2 is high, and a concentration of CO contained in the reformed gas is substantially lowered.

Accordingly, the reformed gas flowing from the condenser 87 is introduced to the warming-up inlet 5i of the warming-up portion 5 through the sixth valve 86 and the second bypass passage 80. As a result, at the time of startup of the reforming apparatus, adhesion of CO to reaction sites of the catalyst 5c of the warming-up portion 5 can be inhibited, combustibility of the main body 50 of the warming-up portion 5 can be enhanced early, the rate of temperature rise of the shift portion 3 can be increased, and purification efficiency of the reformed gas can be enhanced.

In this case, a flow rate of the reformed gas introduced to the warming-up inlet 5i of the warming-up portion 5 can be increased according to a characteristic line X1 illustrated in FIG. 13. Further, a flow rate of the reformed gas introduced to the warming-up inlet 5i of the warming-up portion 5 can be gradually increased as time lapses according to a characteristic line X2 illustrated in FIG. 13. Further, in a condition where catalytic activity of the catalyst 5c of the main body 50 of the warming-up portion 5 can be easily obtained, or the like, a flow rate of the reformed gas can be increased as time lapses while the reformed gas is introduced to the warming-up inlet 5i of the warming-up portion 5 from immediately after the time of startup, as indicated by characteristic lines X3 and X4.

Whether or not the temperature of the catalyst of the main body 50 of the warming-up portion 5 reaches the temperature TA, at which the catalyst of the main body 50 of the warming-up portion 5 can be easily ignited, can be known by detecting the temperature by means of a temperature sensor for measuring a temperature of the warming-up portion 5, in particular, that of the main body 50 of the warming-up portion 5, or can be assumed from elapsed time from the time of startup. In the meantime, when a mode of the fuel cell electric power generation system transfers to normal operation, similarly to the first example, the sixth valve 86 is closed to close the second bypass passage 80, and the reformed gas is not supplied to the warming-up inlet 5i of the warming-up portion 5. In this case, because the fifth valve 85 is opened, the reformed gas flowing from the fuel cell stack 1 flows to the burner 21 through the first return passage 78, the condenser 87, and the fifth valve 85, and is combusted in the burner 21.

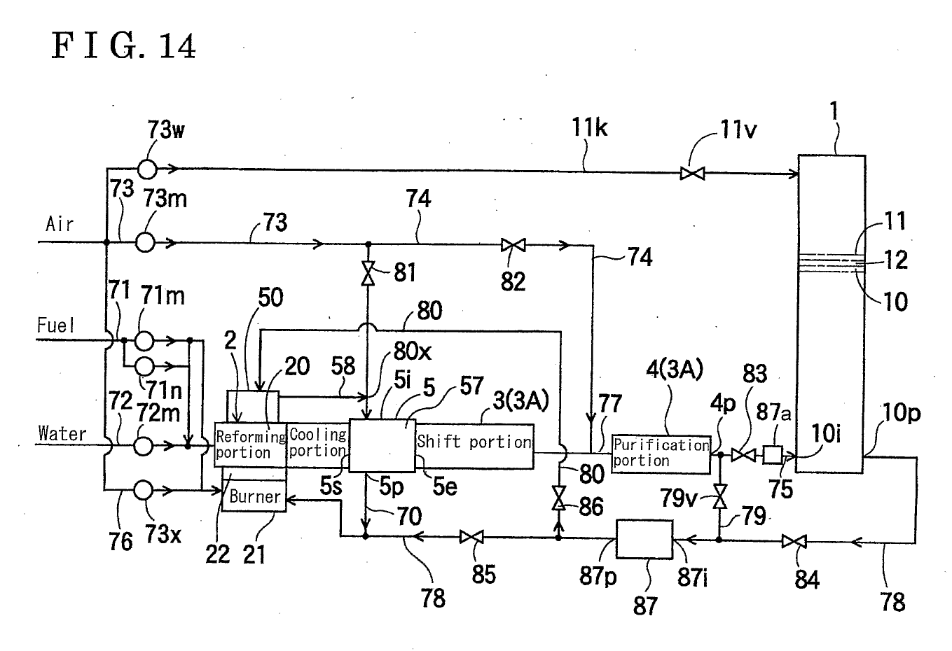

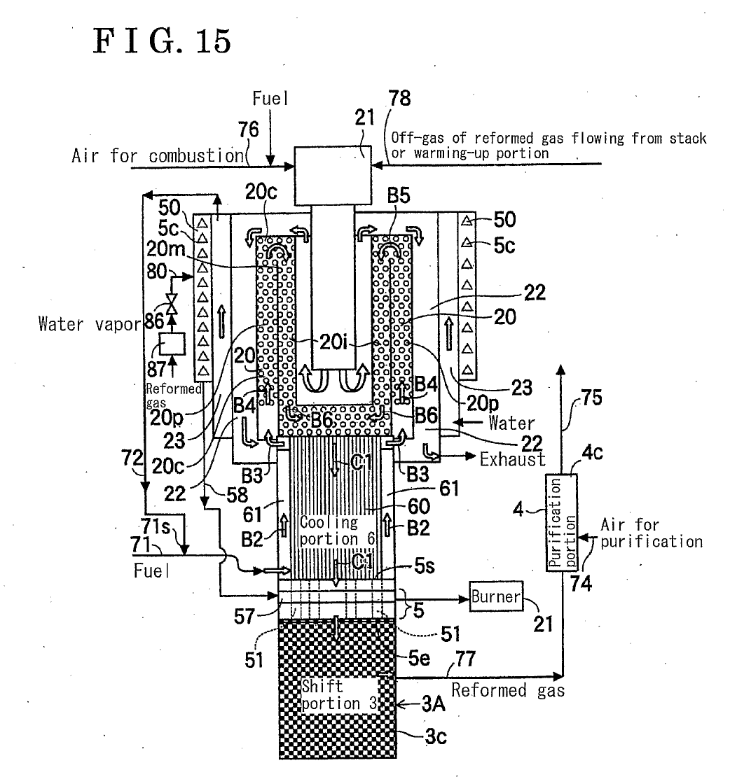

A seventh example will be explained with reference to drawing figures. FIGS. 14 and 15 represent the seventh example. This example has basically similar configuration, action, and effect to that of the first example. In following, difference from the first example will be mainly explained. In this example, the main body 50 of the warming-up portion 5 is provided in an area which can be efficiently heated by transmitted heat from the reforming portion 2. This arrangement of the main body 50 of the warming-up portion 5 configures the means for promoting temperature rise of the main body of the warming-up portion. Precisely, as illustrated in FIG. 6, in the warming-up portion 5, the main body 50 of the warming-up portion 5 for catalytic combustion and a warming-up passage 57 through which the reformed gas heated in the main body 50 of the warming-up portion 5 are provided in separate positions. The main body 50 of the warming-up portion 5 is provided adjacently to the reforming portion 2 and connected to the second bypass passage 80. The warming-up passage 57 is provided adjacently to the shift portion 3 at upstream of the shift portion 3. The warming-up passage 57 communicates with the main body 50 of the warming-up portion 5 through a communication passage 58.

Explanation will be further made. As illustrated in FIG. 15, the combustion zone 22 is provided adjacently to the main body 20 of the reforming portion 2, outside the main body 20 of the reforming portion 2. The vaporization portion 23 is provided adjacently to the combustion zone 22, outside the combustion zone 22. The main body 50 of the warming-up portion 5 for catalytic combustion including the catalyst 5c is provided adjacently to the vaporization portion 23, outside the vaporization portion 23. Accordingly, heat generated in the combustion zone 22 of the reforming portion 2 can be transmitted to the vaporization portion 23, and in turn, to the main body 50 of the warming-up portion 5. Therefore, even at the time of startup, the main body 50 of the warming-up portion 5 can be heated early, and time required for the temperature of the catalyst 5c retained in the main body 50 of the warming-up portion 5 to become a temperature at which the catalyst 5c can be easily ignited can be shortened. As a result, at the time of startup of the reforming apparatus, catalytic combustion can be performed early in the main body 50 of the warming-up portion 5.

Then, off-gas of the reformed gas catalytically combusted in the main body 50 of the warming-up portion 5, which is high temperature, flows through the warming-up passage 57 through the communication passage 58, warms the warming-up passage 57, and reaches the burner 21. Thus, because the warming-up passage 57 of the warming-up portion 5 is warmed at the time of startup, the warming-up portion 5 having the warming-up passage 57 performs warming-up function for heating the shift portion 3 early. Therefore, a rate of temperature rise of the shift portion 3 can increase, and purification efficiency of the shift portion 3 can be enhanced.

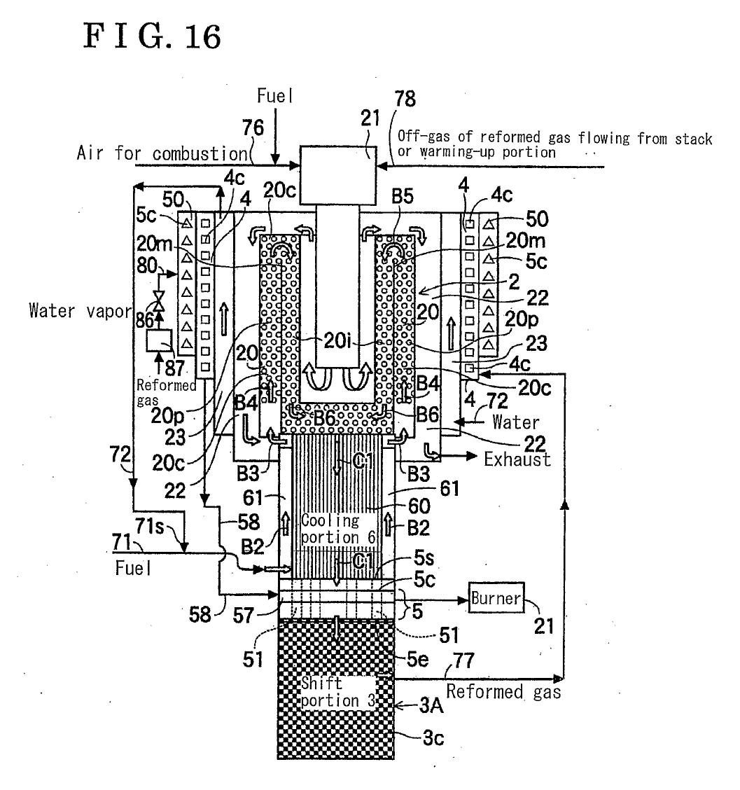

An eighth example will be explained with reference to drawing figures. FIG. 16 represents the eighth example. This example basically has similar configuration, action, and effect to that of the seventh example described above. In following, difference from the seventh example will be mainly explained. In this example, the main body 50 of the warming-up portion 5 is provided in an area which can be efficiently heated by heat transmitted from the reforming portion 2. This arrangement of the main body 50 of the warming-up portion 5 configures the means for promoting temperature rise of the main body of the warming-up portion. Precisely, as illustrated in FIG. 16, the combustion zone 22 is provided outside the main body 20 of the reforming portion 2, which is maintained in high temperature, adjacently to the main body 20 of the reforming portion 2. The vaporization portion 23 is provided outside the combustion zone 22 adjacently to the combustion zone 22. The purification portion 4 is provided outside the vaporization portion 23 adjacently to the vaporization portion 23. Further, as illustrated in FIG. 16, the main body 50 of the warming-up portion 5 for catalytic combustion including the catalyst 5c is provided outside the purification portion 4 adjacently to the purification portion 4. In other words, the purification portion 4 and the main body 50 of the warming-up portion 5 are provided at the reforming portion 2.

Accordingly, heat can be transmitted from the combustion zone 22 in the reforming portion 2 of high temperature to the main body 50 of the warming-up portion 5 through the vaporization portion 23 and the purification portion 4. Therefore, at the time of startup, the main body 50 of the warming-up portion 5 can be heated early, and the temperature of the main body 50 of the warming-up portion 5 can become, in short period of time, a temperature at which the catalyst 5c of the main body 50 of the warming-up portion 5 can be easily ignited. As a result, at the time of startup, catalytic combustion can be performed in the main body 50 of the warming-up portion 5 early, a rate of temperature rise of the shift portion 3 can be increased, and purification efficiency in the shift portion 3 can be enhanced.

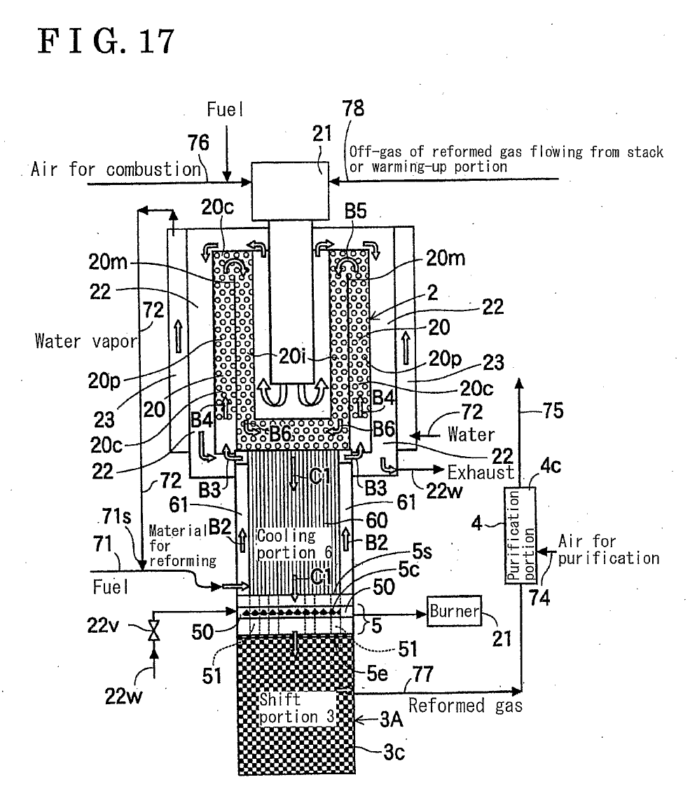

A ninth example will be explained with reference to drawing figures. FIG. 17 represents the ninth example. This example has basically similar configuration, action, and effect to that of the first example. In following, difference from the first example will be mainly explained. As illustrated in FIG. 17, the warming-up portion 5 is provided between the cooling portion 6, which functions as a heat exchange portion also, and the shift portion 3 so that the warming-up portion 5 is provided downstream of the reforming portion 2 and upstream of the shift portion 3. A communication passage 22w is provided so that the combustion zone 22 in the reforming portion 2 communicates with the warming-up portion 5. Accordingly, exhausted gas of high temperature after combusted in the combustion zone 22 flows in the main body 50 of the warming-up portion 5 through the communication passage 22w, and the main body 50 of the warming-up portion 5 can be heated. By doing this, even at the time of startup, the main body 50 of the warming-up portion 5 can be early heated, and the temperature of the main body 50 of the warming-up portion 5 can become, in short period of time, a temperature at which the catalyst 5c of the main body 50 of the warming-up portion 5 can be easily ignited.

In the meantime, as required basis, an opening/closing valve 22v can be provided in the communication passage 22w. In this case, at the time of startup where combustion tends to be unstable, introduction of exhausted gas after combusted in the combustion zone 22 to the warming-up portion 5 can be limited. After that, as combustion becomes stable in the combustion zone 22, the degree of opening of the opening/closing valve 22v can be increased so that a flow rate of the reformed gas introduced to the main body 50 of the warming-up portion 5 can increase.

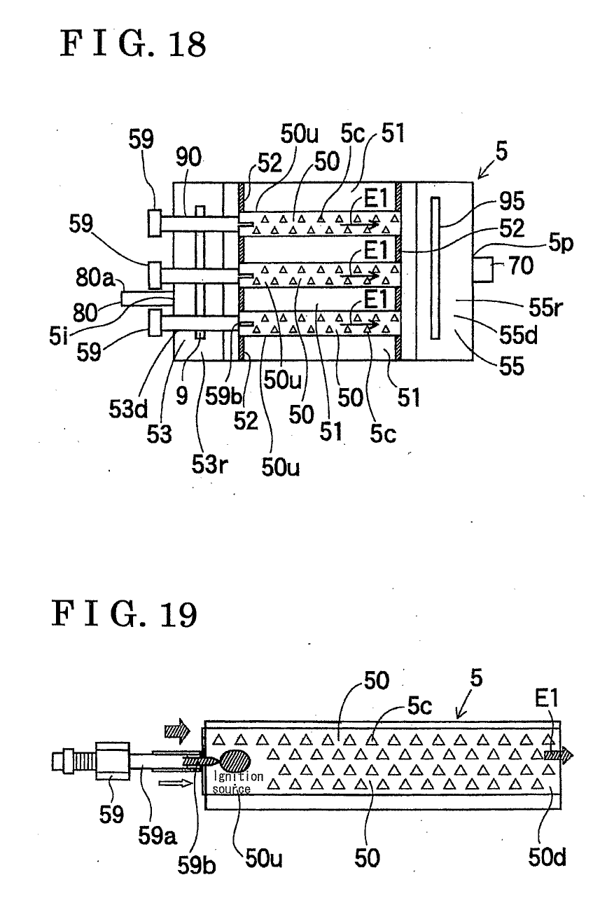

A tenth example will be explained with reference to drawing figures. FIGS. 18 and 19 represent the tenth example. This example has basically the same configuration, action, and effect as in the first example. In following, difference from the first example will be mainly explained. In this example, as illustrated in FIGS. 18 and 19, the means for promoting temperature rise of the main body of the warming-up portion is configured from a heater 59 for heating the main body 50 of the warming-up portion 5. The heater 59 is a glow plug, which has a function for ignition. The heater 59 includes a main body 59a exposed from the main body 50 of the warming-up portion 5 and a heating portion 59b connected to the main body 59a and embedded in the main body 50 of the warming-up portion 5. It is preferable that the heating portion 59b is made of material having good corrosion resistance. The heating portion 59b of the heater 59 is heated when electricity is supplied and performs ignition. A voltage higher than, equal to, or lower than a rated voltage can be applied to the glow plug at the time of ignition.

The heating portion 59b of the heater 59 is locally provided in a flow path through which the reformed gas flows at the time of warming-up operation, at upstream area 50u of the main body 50 of the warming-up portion 5. Accordingly, when the heater 59 is in operation, a pinpoint area in the upstream area 50u of the main body 50 of the warming-up portion 5 can be heated by the embedded heating portion 59b, in other words, locally or intensively. As a result, advantage can be obtained that, even when a concentration of impurity, such as CO, contained in the reformed gas is high, or even when the amount of moisture (water vapor, water droplets) contained in the reformed gas is large, ignition source of catalytic combustion can be easily formed. Because the hydrogen-rich reformed gas flows in the main body 50 of the warming-up portion 5 from the upstream area 50u toward the downstream area 50d, after the ignition, catalytic combustion can be efficiently spread in the main body 50 of the warming-up portion 5 from the upstream area 50u toward the downstream area 50d. This is advantageous for enhancing ignitionability and making catalytic combustion in entire main body 50 of the warming-up portion 5. When temperature rise or ignition is confirmed, the heater 59 is switched off.

In the meantime, as illustrated in FIG. 18, plural main bodies 50 are provided in the warming-up portion 5. The heater 59 is provided in the upstream area 50u of each main body 50 of the warming-up portion 5. However, it is not limited. The heater 59 can be provided, not all of the main bodies 50 of the warming-up portion 5, but one or some of the main bodies 50 of the warming-up portion 5. Further, as illustrated in FIG. 18, because the first gas contact member 9, which captures moisture contained in the reformed gas introduced to the warming-up portion 5, is provided upstream of the heating portion 59b of the heater 59, the heating portion 59b of the heater 59 can be preferably protected.

In this example, at the time of combustion in the main body 50 of the warming-up portion 5, following procedures indicated in (a) and (b) can be employed. By doing so, advantage can be obtained that the amount of electricity supplied to the heater 59 can be low, and even when a concentration of impurity, such as CO, contained in the reformed gas is excessively high, or, even when the amount of moisture (water vapor, water droplets) contained in the reformed gas is excessively high, combustion can be easily made in the main body 50 of the warming-up portion 5.

(a) The heater 59 is repeatedly and intermittently switched on and off at intervals of a predetermined period of time at plural times. In this case, even when excessive moisture is generated in reaction of oxidative combustion of hydrogen contained in the reformed gas as a major component, combutibility in the main body 50 of the warming-up portion 5 can be easily obtained. In addition, because the heater 59 is switched off intermittently, the main body 50 of the warming-up portion 5 can be inhibited from being excessively heated, which is advantageous for inhibiting the temperature of the main body 50 of the warming-up portion 5 from becoming higher than the resistible temperature of the catalyst 5c of the main body 50 of the warming-up portion 5.

(b) At first, the heater 59 is switched on to ignite the main body 50 of the warming-up portion 5. Once the main body 50 of the warming-up portion 5 is ignited, the heater 59 is switched off, and the switched-off state continues. This arrangement is suitable for a situation where the main body 50 of the warming-up portion 5 is not excessively cooled. In addition, because the heater 59 is switched off, the main body 50 of the warming-up portion 5 can be easily inhibited from being excessively heated, which is advantageous for inhibiting the temperature of the main body 50 of the warming-up portion 5 from becoming higher than the resistible temperature of the catalyst 5c of the main body 50 of the warming-up portion 5.

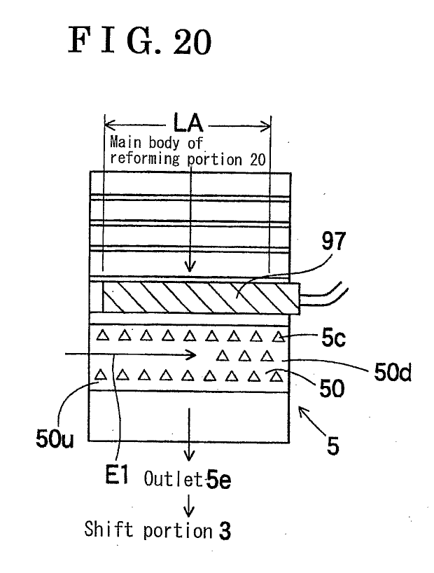

An eleventh example will be explained with reference to drawing figures. FIG. 20 represents the eleventh example. This example has basically similar configuration, action, and effect to that of the first example. In following, difference from the first example will be mainly explained. In this example, as illustrated in FIG. 12, the means for promoting temperature rise of the main body of the warming-up portion is configured from an electric heater 97 (cartridge heater) for heating the main body 50 of the warming-up portion 5 for catalytic combustion. The heater 97 is provided near the main body 50 of the warming-up portion 5 outside the main body 50 of the warming-up portion 5 at an upper side of the main body 50 of the warming-up portion 5 (upstream side of the reformed gas, in other words, near side of the reforming portion 2) so that the heater 97 heats the main body 50 of the warming-up portion 5. As a required basis, the heater 97 can be provided at a lateral or lower side (downstream side of the reformed gas) of the main body 50 of the warming-up portion 5. The heater 97 is provided along a direction of flow of the hydrogen-rich reformed gas flowing in the main body 50 of the warming-up portion 5 (direction indicated by an arrow E1). The heater 97 is provided from the upstream area 50u to the downstream area 50d of the main body 50 of the warming-up portion 5. A length of the heater 97 is LA. The length LA is, for example, 50 to 120%, 60 to 100% of a length of the main body 50 of the warming-up portion 5. In this example, the main body 50 of the warming-up portion 5 can be indirectly heated, which is advantageous for inhibiting the main body 50 of the warming-up portion 5 from being locally and excessively heated and for heating entire main body 50 of the warming-up portion 5 uniformly. These advantages can contribute to make combustion without generating flame in the main body 50 of the warming-up portion 5. In this example also, procedures (a) and (b) described in the tenth example can be employed. Further, a following procedure (c) can be employed.

(c) In a period of time while the main body 50 of the warming-up portion 5 is combusted, or in a substantial part of the period of time while the main body 50 of the warming-up portion 5 is combusted, the heater 59 is continuously in on-state. In this case, even when moisture is excessively produced in process of oxidative combustion of hydrogen, combustibility of the main body 50 of the warming-up portion 5 can be easily ensured.

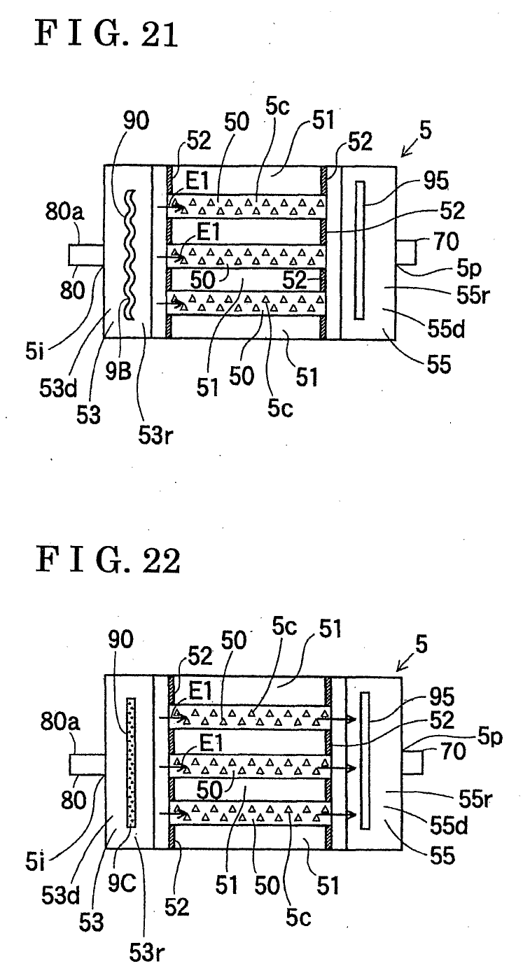

A twelfth example will be explained with reference to drawing figures. FIG. 21 represents the twelfth example. This example has basically similar configuration, action and effect to that of the first example. In following, difference from the first example will be mainly explained. In this example, a first gas contact member 9B serving as the moisture reduction means is provided upstream of the main body 50 of the warming-up portion 5 at the warming-up inlet 5i side. The first gas contact member 9B has a waved cross section so that the surface of the first gas contact member 9B has recessed and protruding portions. Because of the waved shape, collision probability with the reformed gas can be enhanced, which is advantageous for removing moisture (water droplets, or the like) contained in the reformed gas from the reformed gas.

A thirteenth example will be explained with reference to drawing figures. FIG. 22 represents the thirteenth example. This example has basically similar configuration, action, and effect to that of the first example. In following, difference from the first example will be mainly explained. In this example, a first gas contact member 9C serving as the moisture reduction means is provided upstream of the main body 50 of the warming-up portion 5 at the warming-up inlet 5i side. The first gas contact member 9C is made of a porous body having plural fine pores so that the first gas contact member 9C can easily capture moisture contained in the reformed gas. At the time of normal operation, because the warming-up portion 5 is maintained at high temperature, moisture retained in the porous body can disappear. Accordingly, at the time of next operation, the porous body can easily capture moisture contained in the reformed gas.

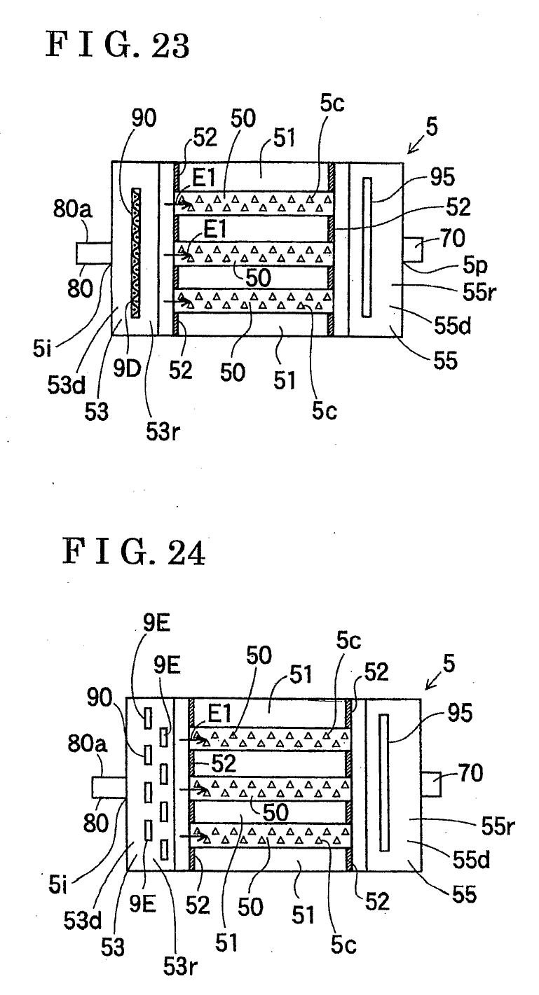

A fourteenth example will be explained with reference to FIG. 23. FIG. 23 represents the fourteenth example. This example has basically similar configuration, action, and effect to that of the first example. In following, difference from the first example will be mainly explained. In this example, a first gas contact member 9D serving as the moisture reduction means is provided upstream of the main body 50 of the warming-up portion 5. The first gas contact member 9D has a mesh shape. It is preferable that the first gas contact member 9D has fine mesh so that the reformed gas introduced to the warming-up inlet 5i of the warming-up portion 5 from the second bypass passage 80 can be highly diffused when the reformed gas collides with the first gas contact member 9D. At the time of normal operation, because the warming-up portion 5 is maintained at high temperature, moisture retained in the mesh can disappear. Accordingly, at the time of next operation, the mesh can easily capture moisture contained in the reformed gas.

A fifteenth example will be explained with reference to FIG. 24. FIG. 24 represents the fifteenth example. This example has basically similar configuration, action, and effect to that of the first example. In following, difference from the first example will be mainly explained. In this example, a first gas contact member 9E is separately arranged, for example, zigzag. Accordingly, contact area with the reformed gas can be ensured.

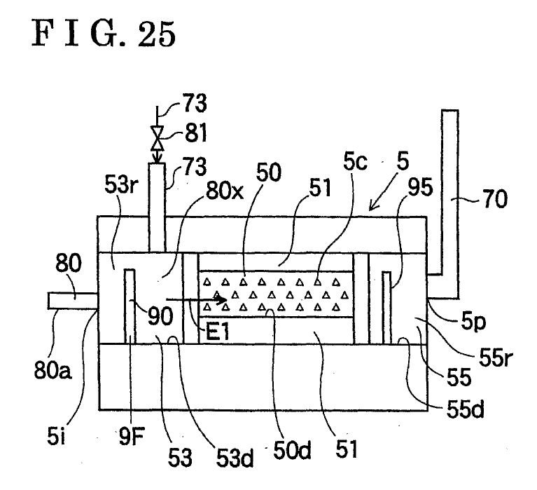

A sixteenth example will be explained with reference to FIG. 25. FIG. 25 represents the sixteenth example. This example has basically similar configuration, action, and effect to that of the first example. In following, difference from the first example will be explained. In this example, a first gas contact member 9F is provided upstream of the merging area 80x where flow of the reformed gas and air merge. The reformed gas of high humidity collides with the first gas contact member 9F before the reformed gas merges with air, which is advantageous for capturing moisture contained in the reformed gas.

According to an aspect of the present invention, a fuel gas processing apparatus includes a gas supply portion for supplying a fuel gas containing carbon monoxide and a catalytic combustion portion for catalytically oxidizing the fuel gas supplied from the gas supply portion. The fuel gas processing apparatus includes a carbon monoxide reduction portion for reducing the amount of carbon monoxide contained in the fuel gas before the fuel gas is supplied to the catalytic combustion portion to enhance combustibility of the catalytic combustion portion.

According to the aspect of the present invention, the amount of carbon monoxide contained in the fuel gas can be reduced in the carbon reduction portion, and the fuel gas can be purified before the fuel gas is supplied to the catalytic combustion portion. Accordingly, excessive adhesion of carbon monoxide to the catalytic combustion portion can be inhibited. Therefore, ignitionability and combustibility can be enhanced in the catalytic combustion portion.

According to a further aspect of the present invention, the fuel gas processing apparatus includes a means for promoting activation for shortening a time required for the carbon monoxide reduction portion to be within an active temperature range when the time of starting the fuel gas processing apparatus is started. Accordingly, the time required for the carbon monoxide reduction portion to be within the active temperature range can be shortened by the means for promoting activation when the time of starting the fuel gas processing apparatus is started.

According to a further aspect of the present invention, the amount of carbon monoxide contained in the fuel gas can be reduced in the carbon monoxide reduction portion, and the fuel gas can be purified before the fuel gas is supplied to the catalytic combustion portion. Accordingly, excessive adhesion of carbon monoxide to a catalyst in the catalytic combustion portion can be inhibited. Therefore, even under the condition that a temperature of the catalytic combustion portion is low, ignitionability and combustibility in the catalytic combustion portion can be enhanced.

According to a further aspect of the present invention, a reforming apparatus includes a reforming portion for reforming materials for reforming to produce a reformed gas and a reformed gas purification portion provided so as to communicate with the reforming portion for purifying the reformed gas generated in the reforming portion. The reforming apparatus further includes a warming-up portion including a main body provided downstream of the reforming portion for warming-up of the reformed gas purification portion at the time of startup of the reforming portion and a means for promoting temperature rise of the main body of the warming-up portion at the time of startup of the reforming portion.

According to the aspect of the present invention, the reformed gas produced in the reforming portion is supplied to the reformed gas purification portion, and the amount of an impurity contained in the reformed gas (for example, carbon monoxide) is reduced. As a result, the reformed gas can be purified.

Because the temperature of the reformed gas purification portion is low at the time of startup of the reforming portion, there is a limitation for enhancing purification efficiency. For overcoming this, the warming-up portion is provided for warming-up of the reformed gas purification portion at the time of startup of the reforming apparatus to raise the temperature of the reformed gas purification portion early. At the time of startup, it is preferable to raise the temperature of the warming-up portion early. Accordingly, the means for promoting temperature rise of the main body of the warming-up portion at the time of startup is provided. As a result, even at the time of startup of the reforming portion, a rate of temperature rise of the reformed gas purification portion can be enhanced, and purification efficiency of the reformed gas can be enhanced early.

According to a further aspect of the present invention, a reforming apparatus includes means for promoting temperature rise of a main body of a warming-up portion for raising a temperature of the warming-up portion early at the time of startup of the reforming apparatus. As a result, even at the time of startup of a reforming portion, a rate of temperature rise of a reformed gas purification portion can be enhanced and purification efficiency of the reformed gas can be enhanced.

According to a further aspect of the present invention, a reforming apparatus includes a reforming portion for reforming a material for reforming to generate a reformed gas and a carbon monoxide (CO) reduction portion for reducing the amount of carbon monoxide contained in the reformed gas generated in the reforming portion. The reforming apparatus further includes a warming-up portion including a main body for warming-up of the CO reduction portion. The reformed gas produced in the reforming portion is introduced to the warming-up portion and combusted at the time of startup of the reforming apparatus. As a result, the CO reduction portion can be warmed up, and reaction for reducing the amount of carbon monoxide contained in the reformed gas can be promoted in the CO reduction portion. The reforming apparatus further includes a moisture reduction means for restraining moisture contained in the reformed gas from adhering to the main body of the warming-up portion.

According to the aspect of the present invention, the reformed gas produced in the reforming portion is supplied to the CO reduction portion. Then, the amount of carbon monoxide contained in the reformed gas is reduced in the CO reduction portion by reaction in which the amount of CO is reduced. Because a temperature of the CO reduction portion is low at the time of startup of the reforming portion, enhancement of the amount of CO reduced in the CO reduction portion has a limitation. For overcoming this, at the time of startup of the reforming apparatus, the reformed gas produced in the reforming portion is introduced to the main body of the warming-up portion. Then, the reformed gas is combusted in the main body of the warming-up portion to raise temperature of the CO reduction portion early. As a result, even at the time of startup of the reforming apparatus, a rate of temperature rise of the CO reduction portion can be enhanced, and reaction in which the amount of carbon monoxide is reduced can be promoted in the CO reduction portion.

In the meantime, the reformed gas produced by reforming tends to contain moisture (water vapor, droplets, or the like) in many cases. If moisture adheres to the main body of the warming-up portion, limitation in ignitionability, combustibility, and temperature rise property of the main body of the warming-up portion is imposed. Regarding this point, according to the aspect of the present invention, the moisture reduction means restrains moisture contained in the reformed gas from adhering to the main body of the warming-up portion at the time of startup. As a result, a rate of temperature rise of the main body of the warming-up portion can be enhanced. Accordingly, at the time of startup, the main body of the warming-up portion can raise a temperature of the CO reduction portion early. As a result, at the time of startup of the reforming apparatus, reaction in which the amount of carbon monoxide is reduced can be promoted in the CO reduction portion.

According to a further aspect of the present invention, a moisture reduction means included in a reforming apparatus restrains moisture contained in a reformed gas from adhering to a main body of a warming-up portion at the time of startup of the reforming apparatus. As a result, at the time of startup, ignitionability, combustibility, and temperature rise property can be improved in the warming-up portion. Accordingly, at the time of startup, the main body of the warming-up portion can raise a temperature of a CO reduction portion early. As a result, even at the time of startup of the reforming apparatus, reaction in which the amount of carbon monoxide can be reduced can be promoted in the CO reduction portion.

Following technical concept can be grasped from above description. A fuel cell electric power generation system including a reforming portion for reforming a material for reforming to generate a reformed gas, a reformed gas purification portion provided so as to communicate with the reforming portion for purifying the reformed gas generated in the reforming portion, and a fuel cell to which the reformed gas is supplied from the reformed gas purification portion, wherein the fuel cell electric power generation system further includes a warming-up portion including a main body for warming-up of the reformed gas purification portion at the time of startup of the reforming portion and means for promoting temperature rise of the main body of the warming-up portion for enhancing temperature rise property of the main body of the warming-up portion at the time of startup of the reforming apparatus.

Following technical concept can be also grasped from above description. A fuel cell electric power generation system including a reforming portion for reforming a material for reforming to generate a reformed gas, a carbon monoxide (CO) reduction portion for reducing the amount of carbon monoxide contained in the reformed gas generated in the reforming portion, and a fuel cell to which the reformed gas is supplied from the CO reduction portion, wherein the fuel cell electric power generation system further includes a warming-up portion including a main body for warming-up of the CO reduction portion by combusting the reformed gas produced in the reforming apparatus and introduced to the warming-up portion at the time of startup of the reforming apparatus to promote reaction in which the amount of carbon monoxide contained in the reformed gas in the CO reduction portion and a moisture reduction means for restraining moisture contained in the reformed gas from adhering to the main body of the warming-up portion at the time of startup of the reforming apparatus.

A fuel cell electric power generation system described above can be utilized for any of stationing, a vehicle, and other applications. In examples described above, a reforming apparatus was applied to a fuel cell electric power generation system. However, it is not limited. The reforming apparatus can also be applied to other systems such as a hydrogen making system.

### INDUSTRIAL USE

A fuel gas processing apparatus described above can be applied to, for example, a hydrogen making system including a fuel gas processing apparatus and a fuel cell electric power generation system including a fuel gas processing apparatus.

1. A fuel gas processing apparatus, comprising:
a gas supply portion for supplying a fuel gas containing carbon monoxide; and
a catalytic combustion portion for catalytically oxidizing the fuel gas supplied from the gas supply portion, and
a carbon monoxide reduction portion for reducing the amount of carbon monoxide contained in the fuel gas before the fuel gas is supplied to the catalytic combustion portion to enhance combustibility of the catalytic combustion portion, wherein
the fuel gas processing apparatus further includes a moisture reduction device for restraining moisture contained in the fuel gas from adhering to the catalytic combustion portion when the time of starting the fuel gas processing apparatus is started.

2. The fuel gas processing apparatus according to claim 1, wherein
the fuel gas processing apparatus further includes a device for promoting activity of the carbon monoxide reduction portion for shortening a time required for the carbon monoxide reduction portion to be within an active temperature range when the fuel gas processing apparatus is started.

3. The fuel gas processing apparatus according to claim 1, wherein
the gas supply portion is a reforming portion including a main body for reforming a material for reforming to generate a reformed gas as the fuel gas and a combustion portion for heating the main body of the reforming portion by combustion.

4. The fuel gas processing apparatus according to claim 3, wherein
heat produced in the main body of the reforming portion and/or in the catalytic combustion portion can be transmitted to the carbon monoxide reduction portion.

5. The fuel gas processing apparatus according to claim 2, wherein
the gas supply portion is a reforming portion including a main body for reforming a material for reforming to generate a reformed gas as the fuel gas and a combustion portion for heating the main body of the reforming portion by combustion, and the device for promoting activity of the carbon monoxide reduction portion includes an exhausted combustion gas passage for supplying an exhausted combustion gas from the combustion portion of the reforming portion to the carbon monoxide reduction portion whereby the carbon monoxide reduction portion can be heated.

6. The fuel gas processing apparatus according to claim 2, wherein
the device for promoting activity of the carbon monoxide reduction portion is a heating portion for heating the carbon monoxide reduction portion.

7. The fuel gas processing apparatus according to claim 2, wherein
the device for promoting activity of the carbon monoxide reduction portion supplies oxygen to the carbon monoxide reduction portion when the time of starting the fuel gas processing apparatus is started.

8. The fuel gas processing apparatus according to claim 2, wherein
the device for promoting activity of the carbon monoxide reduction portion includes an introducing device for introducing the fuel gas containing hydrogen and carbon monoxide to the catalytic combustion portion and an oxygen supplying device for supplying a gas containing oxygen as a main component to the catalytic combustion portion before the fuel gas containing oxygen and carbon monoxide is introduced to the catalytic combustion portion by the introducing device.

9. The fuel gas processing apparatus according to claim 1, wherein
the fuel gas contains hydrogen.

10. The fuel gas processing apparatus according to claim 3, wherein
the carbon monoxide reduction portion is a reformed gas purification portion for purifying the reformed gas generated in the main body of the reforming portion, the reformed gas purification portion provided to communicate with the main body of the reforming portion, a warming-up portion is provided downstream of the main body of the reforming portion, the warming-up portion includes a main body for warming the reformed gas purification portion at the time of starting the reforming portion, the main body of the warming-up portion is the catalytic combustion portion, and the fuel gas processing apparatus includes a device for promoting temperature rise of the main body of the warming-up portion for quickening temperature rise of the main body of the warming-up portion at the time of starting the reforming portion.

11. The fuel gas processing apparatus according to claim 10, wherein
the device for promoting temperature rise of the main body of the warming-up portion is a providing device for providing the main body of the warming-up portion in a flow passage in which the reformed gas generated in the main body of the reforming portion flows toward the reformed gas purification portion downstream of the main body of the reforming portion and upstream of the reformed gas purification portion.

12. The fuel gas processing apparatus according to claim 10, wherein
the device for promoting temperature rise of the main body of the warming-up portion limits introduction of the reformed gas to the warming-up portion at the time of starting the fuel gas processing apparatus when a temperature of the main body of the warming-up portion is lower than that of the main body of the warming-up portion at the time of normal operation of the fuel gas processing apparatus or when a temperature of the main body of the reforming portion is lower than that of the main body of the reforming portion at the time of normal operation of the fuel gas processing apparatus, and increases a flow rate of the reformed gas introduced to the warming-up portion as the temperature of the main body of the warming-up portion rises.

13. The fuel gas processing apparatus according to claim 10, wherein
the device for promoting temperature rise of the main body of the warming-up portion is a providing device for providing the main body of the warming-up portion so that the warming-up portion can be heated by heat transmitted from the reforming portion.

14. The fuel gas processing apparatus according to claim 13, wherein
the main body of the warming-up portion and a warming-up passage are separately provided in the warming-up portion, the main body of the warming-up portion is provided so that the main body of the warming-up portion can be heated by heat transmitted from the reforming portion, and the warming-up passage is provided upstream of the reformed gas purification portion.

15. The fuel gas processing apparatus according to claim 10, wherein
the device for promoting temperature rise of the main body of the warming-up portion includes a heater for heating the main body of the warming-up portion.

16. The fuel gas processing apparatus according to claim 15, wherein
the heater includes an embedded heating portion embedded in the main body of the warming-up portion.

17. The fuel gas processing apparatus according to claim 15, wherein
the heater is provided outside the main body of the warming-up portion.

18. The fuel gas processing apparatus according to claim 15, wherein
the fuel gas processing apparatus further includes a moisture reduction device provided upstream of the heater for capturing moisture contained in the reformed gas.

19. The fuel gas processing apparatus according to claim 10, wherein
the fuel gas processing apparatus further includes a cooling portion provided between the reforming portion and the warming-up portion for cooling the reformed gas before the reformed gas reformed in the reforming portion is introduced to the warming-up portion.

20. The fuel gas processing apparatus according to claim 3, wherein
the amount of carbon monoxide contained in the reformed gas generated in the main body of the reforming portion is reduced in the carbon monoxide reduction portion, the fuel gas processing apparatus includes a warming-up portion including a main body, the reformed gas generated in the main body of the reforming portion is introduced to the main body of the warming-up portion and combusted therein at the time of starting the fuel gas processing apparatus to warm the carbon monoxide reduction portion and thereby to promote reaction in the carbon monoxide reduction portion by which the amount of carbon monoxide contained in the reformed gas is reduced, the main body of the warming-up portion is the catalytic combustion portion, and wherein
the moisture reduction device for restraining moisture contained in the reformed gas from adhering to the main body of the warming-up portion when the time of starting the fuel gas processing apparatus is started.

21. The fuel gas processing apparatus according to claim 20, wherein
the fuel gas processing apparatus further includes a cooling portion provided between the reforming portion and the warming-up portion for cooling the reformed gas before the reformed gas reformed in the reforming portion is introduced to the warming-up portion.

22. The fuel gas processing apparatus according to claim 21, wherein
the cooling portion has a heat-exchange function by which a temperature of the reformed gas reformed in the main body of the reforming portion and supplied into the warming-up portion is lowered, and by which the material for reforming is heated before the material for reforming is supplied to the main body of the reforming portion.

23. The fuel gas processing apparatus according to claim 21, wherein
the moisture reduction device includes a gas contact member for capturing moisture contained in the reformed gas when the reformed gas supplied to the main body of the warming-up portion contacts with a contact portion of the gas contact member.

24. The fuel gas processing apparatus according to claim 21, wherein
the fuel gas processing apparatus further includes an upstream moisture storage portion for storing moisture captured from the reformed gas supplied to the main body of the warming-up portion, the upstream moisture storage portion provided in a flow passage in which the reformed gas flows through the moisture reduction device when the time of starting the fuel gas processing apparatus is started and in the warming-up portion upstream of the main body of the warming-up portion.

25. The fuel gas processing apparatus according to claim 21, wherein
the fuel gas processing apparatus further includes a downstream moisture storage portion for storing moisture, the downstream moisture storage portion provided in a flow passage in which the reformed gas flows through the moisture reduction device when the time of starting the fuel gas processing apparatus is started and in the warming-up potion downstream of the main body of the warming-up portion.

26. The fuel gas processing apparatus according to claim 21, wherein
the moisture reduction device includes a blowing device for blowing a gas other than the reformed gas at the time of ending reforming operation in the reforming portion.
